(19) United States
(12) Patent Application Publication
(10) Pub. No.: US 2026/0268269 A1
(43) Pub. Date: Sep. 10, 2026

(54) GOVERNED EXECUTION GATEWAY WITH INTENT-SCOPED PERMISSIONS AND DEPENDENCY MAPPING FOR STATE TRANSITIONS

(71) Applicant: QMS TECHNOLOGIES INC., Vancouver (CA)

(72) Inventors: Daniele Pietro LIONELLO, Penticton (CA); Scott Nicholas Dante LIONELLO, New Westminster (CA)

(73) Assignee: QMS TECHNOLOGIES INC., Vancouver (CA)

(21) Appl. No.: 19/658,148

(22) Filed: Apr. 24, 2026

Related U.S. Application Data
(63) Continuation-in-part of application No. 18/780,129, filed on Jul. 22, 2024, now Pat. No. 12,651,232.
Application No. 18/780,129 is a continuation of application No. 18/136,637, filed on Apr. 19, 2023, now Pat. No. 12,073,358.
Application No. 18/136,637 is a continuation of application No. PCT/IB2021/000719, filed on Oct. 21, 2021.
(60) Provisional application No. 63/104,135, filed on Oct. 22, 2020.

(51) Int. Cl. G06Q 10/087; G06Q 30/08

(52) U.S. Cl. CPC G06Q 10/087; G06Q 30/08

(57) ABSTRACT

A computer implemented method governs execution of tasks and includes receiving, at a computing system, a request to implement a state transition for triggering a real-word effect. The method identifies, in the request, a declared task type associated with the proposed transition, derives a task-specific authority profile based at least partially on the task type and comprising discrete required permission levels to execute a task of the task type, determines an actor-specific authority profile based on a source of the received request and defines an actor-specific permission level associated with each discrete permission of the task-specific authority profile, and creates an instance-specific authority profile comprising an instance-specific permission level corresponding to a narrower of the corresponding task-specific required permission level and the actor-specific permission level. The method then authorizes implementation of the state transition upon determining that the instance-specific authority profile defines sufficient permissions for each discrete required permission level.

### CROSS-REFERENCE TO RELATED APPLICATIONS

This application is a continuation in part of US Patent Application No. 18/780,129, filed July 22, 2024, which is a continuation of US Patent Application No. 18/136,637, filed April 19, 2023, which is a continuation of International Patent Application No. PCT/IB2021/000719, filed October 21, 2021, which claims the benefit of U.S. Provisional Application No. 63/104,135, filed on October 22, 2020, the entire contents of each of which are incorporated herein by reference.

### FIELD OF THE INVENTION

This disclosure relates to execution governance in operational systems. More specifically, it provides systems and methods that mediate autonomous and human-initiated actions by performing semantic interpretation, intent-scoped authorization, and governed validation of proposed state transitions within a causal world model. Such systems and methods may allow for the use of autonomous agents in parts and assembly supply chains encompassing multiple entities, and in which multiple tiers must be managed.

### BACKGROUND

Modern enterprise systems lack a shared execution state across organizational boundaries. The physical economy therefore operates through independent interpretations of operational events maintained by each participating organization. Every organization maintains its own systems of record—ERP platforms, CRM systems, financial ledgers, inventory systems, logistics platforms, quality management systems, and product lifecycle tools. Each of these systems maintains a local interpretation of operational state based on the transactions it observes.

Documents in these environments represent snapshots of operational belief at a specific point in time. As execution continues and systems update independently across organizations, those snapshots quickly become outdated and interpretations begin to diverge. This divergence produces causal drift: the growing separation between the recorded belief of what has occurred and the actual sequence of events in the world.

For example, a single operational event such as a shipment may exist simultaneously as:
a. a shipment record in one organization’s ERP system
b. a receipt expectation in another organization’s inventory system
c. a logistics update in a carrier platform
d. a liability transfer in a financial system

Each representation evolves independently. Every organization therefore maintains its own version of the same operational event. Consistency is restored later through reconciliation.

In practice, intercompany execution is frequently coordinated through shared spreadsheets, email threads, and manually maintained trackers.

These artifacts track RFQs, quotes, purchase orders, fulfillment status, shipment updates, change orders, and invoice reconciliation across company boundaries.

These spreadsheets effectively become the informal coordination layer between organizations because existing systems of record do not share execution state.

As an example of the problems generated by the existing approach, a medical device manufacturer in Ohio may ship 4,000 units of a Class II surgical instrument to a distributor in Frankfurt. The shipment requires an ISO 13485 quality certificate, an EU MDR compliance declaration, and a liability transfer from the manufacturer's insurer to the distributor's freight policy at the moment goods cross the Atlantic.

In reality, the manufacturer's ERP would record the shipment as dispatched. The logistics carrier would then update its platform with a bill of lading. The distributor's inventory system would then create a receipt expectation. The manufacturer's finance team would then generate an invoice. The distributor's accounts payable system would then schedule a payment.

Each of these discrete systems then take action that is correct according to its own local interpretation of reality. However, this collapses if, for example, the ISO 13485 certificate expired two days before the shipment left the dock. None of these systems would typically catch such a failure because no single system holds a complete picture. The certificate lives in the manufacturer's quality management system. The shipment authorization lived in its ERP. The compliance requirement lived in the distributor's regulatory database. And the carrier's logistics platform had no visibility into any of it.

In the scenario outlined, six weeks later, the distributor's regulatory team might discover the gap during a routine audit. By then, 3,200 units have already been sold to hospitals across Germany, and the required recall costs $4.2 million. The manufacturer's insurer then disputes the liability transfer because the distributor's finance team has already reconciled the payment.

Modern enterprise systems lack a shared execution state across organizational boundaries. Every company maintains its own systems of record — ERP platforms, CRM systems, financial ledgers, inventory systems, logistics platforms, quality management systems, and product lifecycle tools. Each system maintains a local interpretation of operational state based on the transactions it observes.

Documents in these environments represent snapshots of operational belief at a specific point in time. As execution continues and systems update independently across organizations, those snapshots diverge.

This divergence is causal drift: the growing separation between the recorded belief of what has occurred and the actual sequence of events in the world.

Causal drift persists because modern enterprise systems coordinate execution through documents and interpretation rather than through deterministic control of operational state transitions.

This causal drift and the corresponding inconsistencies are compounded because modern transactions involve interactions between autonomous agents, human users, software systems, and devices, any of which may initiate actions that alter the state of governed objects. These actions often carry dependencies, require sequencing, and may propagate consequences across multiple objects or multiple entities. Ensuring that these actions occur safely and consistently requires more than conventional access control or workflow enforcement.

The speed at which modern execution occurs further compounds such problems.

Historically, operational execution occurred at human speed. Documents moved slowly between organizations, allowing discrepancies between systems to be discovered and reconciled before they propagated widely. As automation and machine-driven systems accelerate operational execution, that reconciliation window disappears.

State changes now propagate across systems and organizations at machine speed, causing inconsistencies to spread immediately rather than being corrected through human intervention.

In many modern automation systems this loss of reconciliation time is addressed by inserting human approval gates before execution. AI agents or automated workflows may propose operational actions, but humans must approve those actions before they are allowed to affect operational systems.

This pattern effectively slows machine-driven execution back down to human speed in order to prevent inconsistencies from propagating. While this approach reduces risk, it also reveals the underlying limitation: without deterministic validation of execution state, automation cannot safely operate at machine speed.

As automation accelerates operational systems, reconciliation after the fact becomes structurally insufficient. Execution must instead be validated before commitments propagate.

As modern computing systems increasingly rely on automated and agent-driven components to initiate actions, including those resulting in real-world effects. Such computing systems govern the physical movement of goods, the creation of financial or legal obligations, the irreversible modification of stored data, and execution of regulated decisions. However, the AI systems being deployed to accelerate commerce are fundamentally incompatible with the execution environments they are being plugged into.

A large language model is, at its core, a probabilistic reasoning engine. It predicts the most likely next action based on patterns in its training data. It infers and bridges gaps in logic by generating plausible completions. This makes it an extraordinary reasoning system — capable of drafting purchase orders, analyzing supplier risk, and recommending inventory adjustments.

However, modern enterprise systems operate under open-world assumptions. In open-world reasoning, missing information is tolerated, contradictory information is treated as uncertainty, and systems infer plausible interpretations of incomplete state. An open-world ERP system already tolerates ambiguity. It assumes whatever it is told by an integrated system is approximately true.

However, granting a probability inference engine direct execution authority over an open-world operational environment allows it to confidently execute operational commitments based on states it hallucinated. Legacy systems would typically allow this to proceed, and then attempt to reconcile after the fact.

Returning to the example of surgical instruments, if an AI procurement agent is managing the manufacturer's outbound logistics, the agent would then check the ERP for shipment readiness, querying the quality system for the ISO 13485 certificate. However, it may receive an ambiguous response, such as that the certificate is technically in the system, but its expiration date field is null due to a data migration error. An open-world reasoning system would treat this as uncertainty and infer the most plausible interpretation: the certificate is valid. The agent would then authorize the shipment.

At human speed, this error might be caught by a logistics coordinator who would have called the quality team. At machine speed, the shipment would be dispatched, the invoice is generated, and the payment is scheduled — all before a human could intervene.

Existing access-control models, such as role-based access control (RBAC), grant permissions based on a user or system’s identity or group membership. These models do not constrain permissions according to the specific task the actor intends to perform and therefore cannot prevent misuse of broad privileges by automated actors during narrow, task-specific actions. Workflow engines and business process systems define sequences of operations, but they rely on external enforcement for data integrity, do not interpret autonomous-agent intent, and provide no mechanism for validating proposed state transitions against governed domain rules.

API gateways and orchestration frameworks provide routing, transformation, or aggregation of service calls, but they assume that upstream systems make valid requests. These technologies neither validate the semantic intent of a request nor evaluate its safety relative to governed object states, dependencies, or constraints. In environments where autonomous agents or multi-system processes can issue requests, such lack of validation may result in inconsistent and incompatible or contradictory states, unauthorized modifications, or cascading operational errors.

The heavy use of autonomous agents introduces additional failure modes. An agent may submit transitions that appear syntactically valid but violate domain semantics or downstream constraints. Multiple agents may engage in repeated negotiation attempts without convergence. Traditional systems lack mechanisms for identifying such patterns or enforcing governed escalation rules. Accordingly, as in the case of other requests, mechanisms assume that once access is granted to an automated agent, execution is legitimate.

As a result, automated systems have issued refunds and fare commitments that resulted in legally enforceable financial obligations, released or attempted to release physical goods without satisfying prerequisite conditions, deleted or irreversibly modified production data, and issued regulated decisions such as insurance or healthcare denials with legal and compliance consequences. In each case, execution occurred optimistically, and remediation was attempted only after an irreversible state resulted.

Existing approaches attempt to address these risks through workflow automation, post-hoc approval processes, or authorization systems that issue scoped permissions or tokens. However, these approaches are typically embedded within execution systems, rely on optimistic execution followed by reconciliation or rollback, or focus on access control rather than on the admissibility of the resulting state transition itself. As a result, execution may proceed even when prerequisite conditions are unmet, required approvals are missing, or downstream consequences are unacceptable.

Accordingly, there exists a need for a system that determines, prior to execution, whether a proposed action or state transition is permitted to come into existence at all. Such a system may operate as a non-bypassable decision boundary that evaluates, for example, declared intent, authority, current state, dependencies, and constraints before allowing execution systems to initiate real-world activity. By preventing illegitimate execution from occurring in the first instance, such a system can avoid physical movement of goods, creation of financial obligations, destruction of data, and other irreversible outcomes, while also improving computer operation by reducing downstream retries, compensating transactions, and reconciliation logic.

There is a further need for such a system to take the form of a governed execution gateway that can perform at least some of:

interpreting a proposed action at a semantic level to determine task intent;

deriving and applying intent-scoped permissions rather than global permissions;

evaluating every proposed state transition against a governed causal world model;

enforcing deterministic transition outcomes;

detecting repetitive or cyclic proposals from autonomous agents; and

providing structured feedback grounded in verified world state.

One implementation of the missing architectural layer can then be a system that represents operational commitments as deterministic state transitions across organizations.

This layer may coordinate workflows and propagate state across connected systems, but those behaviors are secondary effects. Its defining role is to determine whether proposed operational commitments may become authoritative state transitions across organizations.

There is therefore a need for such a layer that models operational commitments as canonical execution events within a governed causal execution graph. More generally, there is a need for a deterministic admission boundary that determines whether proposed operational commitments may become authoritative execution states across organizations.

As an example of an environment in which such a system can be implemented, a supply chain is discussed as a context in which such a governed execution gateway can be implemented. A supply chain is a system of organizations, people, events, information and resources involved in supplying a product or service to a customer. Supply chains can become particularly complex where there are many tiers of different entities involved.

While increased globalization of commerce has propelled supply chains to be used at an international level, this has also generated several new challenges such as the substitution of entities when certain entities become unable to fulfil their purpose. In existing systems, if a link in a supply chain for a manufacturer is broken, it could take weeks or months to repair that link, as a new supplier must be ramped up, potentially retooled, and new parts must be tested for compliance with end product requirements.

Further, because the new supplier is unlikely to be local to the manufacturer, sample parts typically must be shipped back and forth for approvals, which takes additional time. However, because of the large expense associated with tooling and ramping up a new supplier, and with the cost savings associated with a lean assembly line, backup suppliers are rarely ramped up for links in a supply chain, so long as the existing links are functional.

Further, if a link in a supply chain is broken, it often results in a complete loss of an upstream supply chain, since upstream supply chains are often owned, or controlled by, a mid-tier supplier. As such, if a manufacturer loses a supplier for a supplier for a mid-level sub assembly, or if a manufacturer chooses to switch suppliers, all components incorporated into that mid-level sub assembly may need to be resourced.

Typically, if a manufacturer would like to control more of their supply chain, they must manually make introductions between suppliers at different tiers of their supply chain. After such introductions are made, suppliers at different tiers interact directly, and no information about the provision of parts or services between tiers are available to the manufacturer. As such, after an introduction is made, a manufacturer may not know anything about quality statistics about parts provided between tiers of their supply chain, or about order quantities. It is therefore difficult to audit any part of the relationship.

These challenges are further reflected in the context of a governed execution gateway, where there may be a need to evaluate the result of an authorized state change propagating across multiple entities, where a party implementing the state change has no access to the internal systems associated with those secondary entities.

There is therefore a need for a representation of dependencies across multiple entities that can allow for an evaluation of a proposed state change as it propagates across multiple entities.

Further, operational systems often rely on domain-specific application logic to manage object lifecycles, enforce validation rules, and govern transitions between states. Conventional architectures embed these rules in procedural code or in rigid workflow structures that must be modified whenever domain requirements change. Such systems are difficult to adapt, extend, or reuse across different operational domains because the execution logic and the domain semantics are tightly coupled.

Existing workflow engines typically represent process flows using notations such as BPMN or statecharts. These systems emphasize task ordering or routing rather than governed state transitions, constraint enforcement, or multi-entity consistency. While they may provide tools for modeling processes, they generally lack mechanisms to express governed dependencies between objects, enforce cross-object constraints, or represent causally linked transitions across multiple entities.

Rule engines and declarative automation systems allow certain logic to be configured externally but are not designed as domain-agnostic execution substrates. They do not enforce deterministic state transitions in accordance with governed workflows, nor do they provide mechanisms for mirrored or synchronized state propagation between entities.

Furthermore, none of the existing systems integrate dynamic domain instantiation, governed state transition enforcement, causal dependency modeling, and consistent multi-entity propagation within a single execution architecture. This absence creates challenges for organizations that require fine-grained control over object lifecycles, high integrity of state transitions, and rapid reconfiguration of operational logic to accommodate new domains or evolving requirements.

There is a need for an execution substrate that:
a. separates execution logic from domain-specific semantics,
b. allows domains to be defined entirely through external configuration files,
c. enforces governed state transitions and dependencies,
d. maintains a causal world model capturing object relationships and cross-entity effects, and
e. provides deterministic, synchronized propagation of state transitions across multiple entities.

This background information is intended to provide information that may be of possible relevance to the present invention. No admission is necessarily intended, nor should be construed, that any of the preceding information constitutes prior art against the present invention

### SUMMARY

A platform is described for implementing a governed execution gateway with intent scoped permissions and dependency mapping for state transitions. Such a platform may then leverage a further described platform for mapping and tracking dependencies and relationships between multiple entities in the context of a causal world model by which state transitions can be evaluated for validity.

Accordingly, a platform is first described for realizing the potential of a core supply chain management system by mapping and tracking the dependencies and relationships between those solutions to manage the production of complex assemblies across many-tiered supply chains. There are two primary components to this project. While the platform is presented in the context of a supply chain management system, it is noted that variations of such a platform may be provided for supporting state transitions in other contexts in which cross-entity propagations are implicated.

First is a dependency framework, which serves to process and store relationships between orders/parts in a supply chain management system. This can be seen as a graph database with all of the back-end systems and infrastructure required to support it. Introduction of a subset of the core order processing into a new node-based microservice architecture adds efficiency to supply chain management.

An engine implementing such graph computation and database library features can reduce the system requirement for a highly complex core of such a graph dependency engine. Such an engine may then allow for the storage of relationships between entities, including vendors, orders, and parts, in order to allow for complex querying of such relationships in the graph database, and to otherwise support the components required for implementation of the dependency framework.

Such a system may then allow for visualization of dependency graphs, and may allow linking of orders and parts as dependencies with a user interface workflow. Such a system may then be able to generate and provide alerts for order graphs that have warnings, and provide the ability for different parties to view differently permissioned portions of such a dependency graph.

Further, once dependencies are graphed in a production map, additional supply chain features may be provided, such as provision of supply chain redundancies and failover procedures. Such a production map may further provide additional information and analytics to parties having permission to view such information. Further, such a production map may allow users to permission part of their supply chain to third parties, or require their supply chain to use specified third parties to satisfy required dependencies. Finally, such a production map may be automatically generated by way of the dependency graphs created through an RFQ process. Such an RFQ process may be iterative, such that dependencies are populated throughout a supply chain using information provided in automatically generated dependency RFQs.

Also provided is a governed execution gateway and a separate execution substrate. The governed execution gateway evaluates proposed state transitions before they are applied to governed objects within an operational environment. The gateway receives structured proposals from autonomous agents, human users, systems, or devices and interprets each proposal through a semantic action layer that identifies the actor’s declared task intent. An intent-scoped authorization engine derives a permission profile that constrains permissible operations based solely on the declared task type, independent of any broader global permissions associated with the actor.

In some embodiments, a governed causal world model represents objects, states, transitions, dependencies, constraints, and cross-entity effects. A validation engine can evaluate each proposed transition against this model to ensure state consistency, dependency satisfaction, constraint compliance, and safe downstream consequences. A deterministic decision engine determines whether the proposed state transitions is admissible, where admissible transitions are permitted to form binding operational state and non-admissible transitions do not result in state formation. A watchdog mechanism can detect repetitive or cyclic proposals and escalates unresolved interactions to designated human roles. A feedback interface can return structured results, including updated state information or rejection reasons, enabling autonomous systems to align further reasoning with verified operational truth.

In this way, embodiments provide a domain-agnostic safety and governance boundary for all operational actions, ensuring that autonomous and human-initiated proposals are executed only when permissible according to governed state, dependencies, and constraints.

Accordingly, in some embodiments a governed execution gateway mediates all attempts by autonomous agents, human users, software systems, or devices to perform state transitions on governed objects within an operational environment. The gateway serves as a semantic, intent-aware boundary that separates actor-driven proposals from the governed execution substrate that applies state transitions.

The gateway receives proposed transitions in the form of structured proposals that identify the actor, the target objects, the proposed data, and a declared semantic action or task type. A semantic action layer interprets the declared task type and constrains the proposal to a predefined category of coarse-grained, domain-agnostic operations. These semantic actions abstract away low-level operations, ensuring that all actors—particularly autonomous agents—interact only through safe and semantically meaningful action spaces.

Embodiments include intent-scoped authorization. Rather than relying on an actor’s global permissions, the gateway derives a task-specific permission profile from the declared intent. This ensures that the actor may perform only the operations associated with that task type, preventing unintended or unauthorized modifications even when the actor possesses broader system privileges.

A governed causal world model may represent all current object states, permitted transitions, dependency conditions, constraint expressions, and cross-entity propagation rules. The gateway invokes a validation engine to evaluate each proposal against this model. The validation engine determines whether the proposed transition is allowed from the object’s current state, whether prerequisite dependencies and approval requirements have been satisfied, whether referenced objects exist and are in compatible states, and whether executing the transition would cause any prohibited downstream consequences.

Overall, embodiments can provide a universal, domain-agnostic safety and governance layer that ensures proposed operational actions are semantically meaningful, authorized according to intent, validated against causal rules, and executed only when fully compliant with governed constraints.

Also provided are systems and methods for a configurable execution substrate that performs governed state transitions across diverse operational domains. The substrate includes a domain-agnostic execution engine that loads one or more external configuration files defining object types, states, transitions, workflows, roles, dependencies, and constraints. Upon loading the configuration, the engine constructs a governed domain model representing the operational structure and permitted behaviors for governed objects.

A governed causal world model tracks all object states, dependencies, constraints, and cross-entity propagation rules, as discussed with respect to the execution gateway. The execution engine applies state transitions only when permitted by both the domain model and causal world model, ensuring deterministic and logically consistent behavior. A propagation mechanism enforces state synchronization across entities, including mirrored or multi-ledger representations where multiple entities maintain shared or dependent states.

The substrate allows new operational domains to be instantiated by providing new configuration files without modifying engine code. This architecture enables a single execution engine to operate across varied environments while maintaining governable, causally validated, multi-entity consistency.

Accordingly, the systems and methods described herein introduce a configurable, governed execution substrate capable of supporting arbitrary operational domains through external configuration without requiring modification to core execution code.

A configurable, governed execution substrate is capable of enforcing deterministic and causally consistent state transitions across arbitrary operational domains. Unlike conventional workflow systems or domain-specific applications, the substrate separates execution logic from domain semantics, enabling new operational domains to be instantiated through external configuration files without modifying underlying engine code.

The execution substrate includes a domain-agnostic execution engine that performs governed state transitions. One or more configuration files define the domain model, specifying object types, states, transitions, workflows, dependency structures, approval requirements, roles, and constraint expressions. When the configuration is loaded, the execution engine instantiates a governed domain model that represents the operational semantics of the domain. This instantiation process allows entirely different domains – commercial, scientific, industrial, administrative, or otherwise – to operate on the same engine.

A governed causal world model, such as that used for the execution gateway described, tracks the current state of all governed objects and their interdependencies. The world model captures cross-object relationships, dependency rules, constraints, and cross-entity propagation requirements. When a transition request is issued – whether originating from an execution gateway, system trigger, or other mechanism – the execution engine evaluates the request against the governed domain model and causal world model to ensure that the transition is permissible, valid, and safe.

If validated, the execution engine applies the transition deterministically. Transitions may trigger dependent transitions on related objects based on causal rules. A propagation mechanism synchronizes state changes across entities, ensuring consistency in environments where multiple systems or organizations maintain mirrored or interdependent representations of governed objects.

Accordingly, the systems and methods described provide a universal substrate for governed execution, allowing organizations to construct, modify, and extend operational domains using configuration files alone. This architecture enables rapid adaptation to changing requirements, improves consistency in multi-entity environments, and ensures that all state transitions are validated and executed according to governed rules defined externally from application code.

In some embodiments, a computer implemented method is provided for governing execution of tasks. The method includes receiving, at a computing system, a request to implement a state transition for triggering a real-word effect.

The method then proceeds to identify, in the request, a declared task type associated with the proposed transition, derive a task-specific authority profile based at least partially on the declared task type, the task-specific authority profile comprising a plurality of discrete required permission levels to execute a task of the declared task type, determine an actor-specific authority profile based on a source of the received request to implement the state transition, the actor-specific authority profile defining an actor-specific permission level associated with each of the discrete permissions of the task-specific authority profile, and create an instance-specific authority profile, the instance-specific authority profile comprising an instance-specific permission level corresponding to a narrower of the corresponding task-specific required permission level and the actor-specific permission level.

The method then authorizes implementation of the state transition upon determining that the instance-specific authority profile defines sufficient permissions for each discrete required permission level.

In some embodiments, the method includes evaluating the requested state transition against a governed causal world model representing current state data and dependency requirements and defining a hypothetical resulting state following the requested state transition, where authorizing implementation occurs upon determining that the hypothetical resulting state is valid.

In some such embodiments, the hypothetical resulting state is validated deterministically to confirm required predecessor states, mandatory linked object existence, and dependency conditions across multiple objects.

In some embodiments utilizing a governed causal world model, the method includes determining that the hypothetical resulting state is invalid, identifying a modification to the request that preserves a semantic intent of the request, applying the identified modification to the request and reevaluating the requested state transition.

In some embodiments utilizing a governed causal world model, the governed causal world model includes a current state of every governed object, relationships and dependencies among objects, and cross-entity state mappings.

In some such embodiments, the evaluating of the requested state transition against the governed causal world model includes confirming that all object states of the hypothetical resulting state conform to allowed object states, that all dependencies of the hypothetical resulting state conform to dependency rules of the causal world model, and that all predicted consequences resulting from the hypothetical resulting state conform to cross-entity propagation rules.

In some embodiments utilizing a governed causal world model, the evaluating of the requested state transition against the governed causal world model includes applying deterministic validation rules to a causal execution graph, where the results of the application to the causal execution graph determine whether the hypothetical resulting state is valid.

In some such embodiments, the causal execution graph defines allowed object states, allowed object transitions, and dependency rules across a plurality of entities.

In some such embodiments, the actor-specific authority profile is associated with one of the plurality of entities, and the one of the plurality of entities does not have direct access to information governing the causal world model with respect to a second entity of the plurality of entities.

In some such embodiments, implementation of the state transition triggers a creation of a legally binding agreement between the first entity and the second entity.

In some embodiments related to a plurality of entities, the state transition is to initiate a release of physical goods for shipment and wherein implementation of the state transition triggers generation of a warehouse pick instruction or carrier dispatch at the second entity.

In some embodiments, upon receiving the request to implement a state transition, an ingestion interface normalizes the request prior to identifying the declared task type.

In some such embodiments, following normalization, the identification of the declared task type is based on semantically mapping the normalized request to one or more predefined task type.

In some such embodiments, the discrete required permission levels are defined based on the predefined task type.

In some such embodiments, the actor-specific authority profile defines at least one actor-specific permission level broader than a corresponding required permission level of the discrete required permission level, and wherein the resulting instance-specific authority profile comprises an instance-specific permission level narrower than the at least one actor-specific permission level.

In some embodiments in which discrete required permission levels are defined based on the predefined task type, the request to implement a state transition comprises an identity of a source of the request, a semantic action, an object reference, and at least one proposed attribute value.

In some such embodiments, the semantic action requires a modification of one field of a plurality of fields but does not require modification of a second field of the plurality of fields, and wherein the actor-specific authority profile defines a permission level sufficient to modify both the first and second field of the plurality of fields, and wherein the instance-specific permission level authorizes modification of the first field but not the second field of the plurality of fields.

In some embodiments in which discrete required permission levels are defined based on the predefined task type, the discrete required permission levels include at least one variable permission level, where the resulting instance-specific authority profile contains a corresponding instance-specific permission level based on the corresponding actor-specific permission level upon determining that the actor-specific permission level is within a range of the variable permission level.

In some embodiments in which discrete required permission levels are defined based on the predefined task type, the identity of the source of the request identifies two actors having different actor-specific authority profiles, and a resulting actor-specific authority profile includes a highest permission level associated with one of the corresponding actors for each of the actor-specific permission levels.

In some such embodiments, the two actors are associated with two corresponding distinct entities, and wherein a relationship between the two distinct entities is defined by a governed causal world model representing current state data and dependency requirements, and wherein the task-specific authority profile defines discrete required permission levels at each of the two distinct entities.

In some embodiments, the state transition is to initiate a release of physical goods for shipment and wherein implementation of the state transition triggers generation of a warehouse pick instruction or carrier dispatch.

In some embodiments, the state transition is to initiate issuance of a refund, credit, or payment, wherein implementation of the state transition triggers transfer of funds or settlement of a payment instrument.

In some embodiments, the state transition is to initiate a write or delete operation against persistent storage, wherein implementation of the state transition triggers irreversible modification or destruction of stored data.

In some embodiments, the method further includes implementing the state transition to trigger the real-world effect following authorization of the implementation or following a determination that the proposed state transition is admissible.

In some such embodiments, implementing the state transition comprises constructing an instantiated domain model for driving execution by a domain agnostic execution engine.

In some such embodiments, constructing the instantiated domain model comprises generating object schemas, creating state machine structures, binding transitions to conditional rules, loading workflow graphs, building dependency maps, and mapping roles to transition permissions.

In some such embodiments, the constructing of the instantiated domain model is governed by one of a plurality of configuration files and wherein different configurations files of the plurality of configuration files define different domain models, and wherein the domain agnostic execution engine can be driven by any of the different domain models.

### BRIEF DESCRIPTION OF THE DRAWINGS

FIG. 1 illustrates a part sharing overview, in accordance with this disclosure.

FIG. 2 shows a system for implementing the parts sharing framework and for generating production maps in accordance with this disclosure.

FIG. 3 is a flowchart illustrating a method for permissioning part manufacturing in accordance with this disclosure.

FIG. 4 shows a database diagram for providing permissioning functionality in accordance with this disclosure.

FIG. 5 is a sample production map for manufacturing a part in accordance with this disclosure.

FIG. 6 is a flowchart illustrating a method for resolving manufacturing dependencies in accordance with this disclosure.

FIG. 7A illustrates an RFQ graph illustrating an ASK process, in accordance with this disclosure.

FIG. 7B illustrates an RFQ graph illustrating a TELL process, in accordance with this disclosure.

FIG. 8 shows a more complex order, in accordance with this disclosure.

FIG. 9 is a flowchart illustrating a gateway architecture for determining whether a request to implement a state transition is to be executed.

FIG. 10 is a method for semantically mapping a request to implement a state transition in the context of the gateway architecture of FIG. 9.

FIG. 11 is a method for defining an instance-specific authority profile in the context of the gateway architecture of FIG. 9.

FIG. 12 illustrates a validation pipeline for use in the context of the gateway architecture of FIG. 9.

FIG. 13 illustrates potential executable decisions generated by the gateway architecture of FIG. 9.

FIG. 14 illustrates a governed causal world model for use in the validation pipeline of FIG. 12.

FIG. 15 illustrates validation of requested state transition in the context of a governed causal world model.

FIG. 16 illustrates a validation check in accordance with this disclosure propagated across multiple entities.

FIG. 17 illustrates the execution of the proposed state transition upon confirming validation across the governed causal world model.

FIG. 18 illustrates a separation of an engine configuration from a corresponding execution engine.

FIG. 19 illustrates a domain instantiation process.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

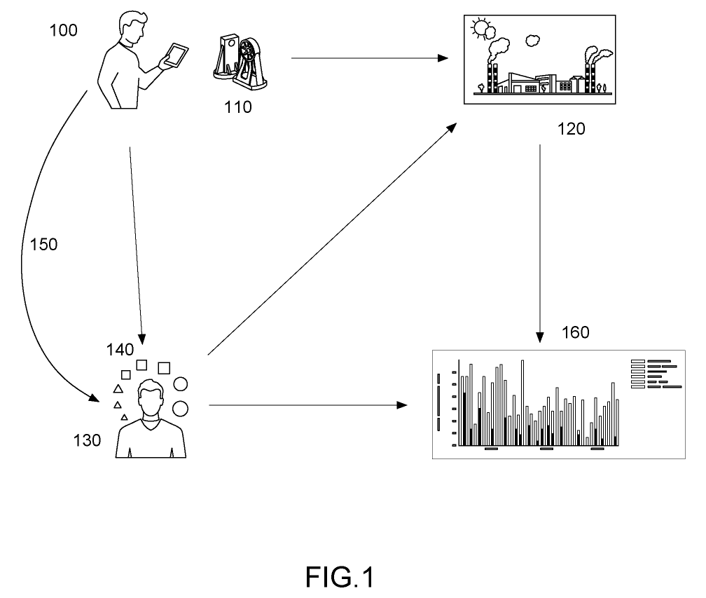

FIG. 1 illustrates a part sharing overview, in accordance with this disclosure. As shown, a first user 100 creates a product 110 with a vendor company 120. That product is typically described herein as a part, but it may also be a process or assembly. The product 110, as well as associated manufacturing details are then recorded in a manufacturing template associated with the first user 100.

If the first user 100 wishes to share the product 110 with a second user 130, the first user may then grant permission to the second user to leverage the manufacturing template for the product 110. The second user 130 may then use the manufacturing template to engage the vendor company 120 to manufacture the product 110.

When the second user 130 engages the vendor company 120 in this way, the relationship generates order statistics 140, which are typically viewable by the first user 100. As such, when the second user 130 orders parts by way of a manufacturing template “owned” by the first user 100, the first user can view 150 details of those orders.

Further, the manufacturing process executed by the vendor company 120 on behalf of the second user 130 typically generates quality analytics data 160. This data 160 may include, for example, data related to number of part revisions, delivery time, part conformance, and order conformance. The data 160 may further include non-conformance reports (NPR) that can be viewed by the first user 100 independently of statistics generated based on the data 160.

Typically, the quality analytics data 160 is stored in a database, and may be viewable by the first user 100. In some embodiments, the quality analytics data 160 is combined with comparable quality analytics data 160 for manufacturing directly authorized or ordered by the first user 100, such that all parts permissioned by way of the manufacturing template contribute to a combined robust data set for analyzing quality of the vendor company’s 120 manufacturing capabilities.

In this way, a first user 100 may maintain control of manufacturing processes, and may continue to monitor manufacturing quality, even if they are separated from those processes by multiple tiers of a supply chain, as discussed in more detail below.

Further, when assigning permissions to a second user 130, the first user 100 may limit those permissions to, for example, a limited number of parts, limited revisions, and limited abilities to share further.

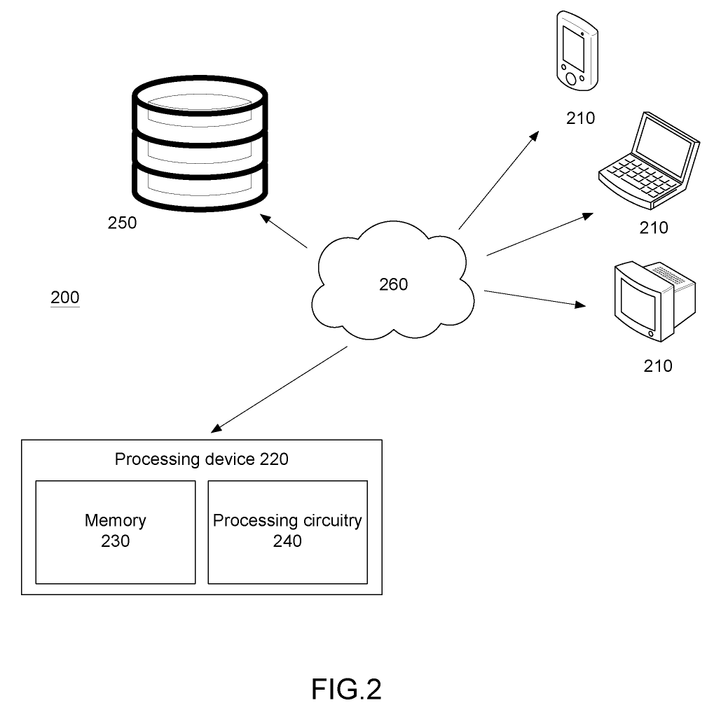

FIG. 2 shows a system 200 for implementing the parts sharing framework and for generating production maps in accordance with this disclosure. As shown, the system 200 may comprise a plurality of user interface devices 210 used by the first user and the second user to access the system and a processing device 220, such as a server for implementing the methods described herein.

The processing device 220 typically includes a memory 230 and processor circuitry 240. The memory 230 stores a plurality of instructions for executing the described methods, and the processor circuitry 240 is linked to the memory and executes those instructions.

The processing device 220 may further comprise or be linked to one or more databases 250 for storing data associated with the methods described herein. The user interface devices 210 may be computers accessible by users, including laptop computers, smartphones, and tablet computers, and may be connected to the processing device 220 by way of a network connection. Such network connection may be, for example, the internet 360.

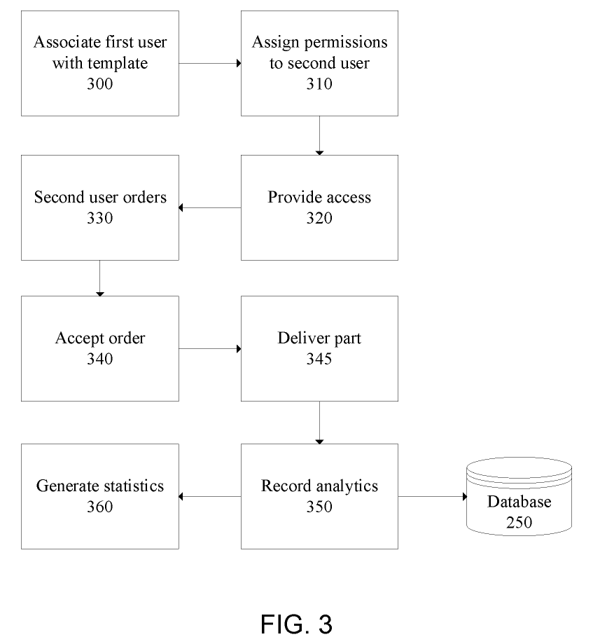

FIG. 3 is a flowchart illustrating a method for permissioning part manufacturing in accordance with this disclosure. As shown, and as noted above, a system 200 implementing the method initially associates a first user 100 with a part manufacturing template for the product 110 to be shared (at 300). The part manufacturing template defines a vendor 120 for providing the product 110, in this example a part, associated with the part manufacturing template.

The system 200 then receives an indication from the first user 100 to assign permissions associated with the part manufacturing template associated with the part 110 to a second user 130 (at 310). The indication may be received at a user interface device 210 associated with the first user 100.

The system 200 then provides the second user 130 with limited access to the part manufacturing template for the part 110 (at 320) in accordance with the permissions assigned by the first user 100. The second user may then order (at 330) instances of the part 110 from the vendor 120 defined in the part manufacturing template.

The system 200 then accepts (at 340) an order for an instance of the part 110 placed by the second user 130. This acceptance may be at the processing device 220 if the vendor 120 has delegated the right to accept new orders, or it may be by the vendor 120 at an associated user interface device 210.

In some embodiments, after the second user 130 places an order (at 330), and the vendor 120 accepts the order (at 340), completed instances of the part 110 are delivered (345) directly to the second user 130 in accordance with the manufacturing template. Further, the manufacturing template may define terms for orders placed by the second user 130.

During and following fulfillment of the order placed by the second user 130 and accepted by the vendor 120, the system 200 may record analytics at a database 250 (at 350) accessible by the first user 100, and related to the order placed by the second user 130. These analytics may be order statistics 140 for orders placed by the second user. Alternatively, or in addition, these analytics may be quality analytics 160 associated with manufacturing of the part by the vendor 120.

In some embodiments, the analytics recorded are then used to generate statistics (at 360) for use by the first user 100. In some embodiments, the analytics or the resulting statistics are accessible by the first user 100 but are not accessible by the second user 130. The analytics and resulting statistics discussed herein may comprise, for example, statistics related to numbers of part revisions and delivery time. Such delivery time statistics may include, for example, statistics comparing actual delivery time to projected delivery time for the vendor 120.

As discussed above, the database 250 may include data for all instances of the part 110 placed with the vendor 120 based on the part manufacturing template, regardless of which user 100, 130 placed the corresponding order. Further, if the user 100 granted permissions to additional users other than the second user 130, analytics associated with parts 110 manufactured under those permissions may be included in the database 250 as well. In some embodiments, the database may be accessible by the first user 100, but not by the second user 130.

As discussed in more detail below, the parts sharing method described herein may be used to share parts for use in the first user’s 100 supply chain that are not directly managed by the first user. As such, if the first user 100 has developed a part 110 with a second tier manufacturer and issues a request for quote (RFQ) to first tier manufacturers, the first user 100 may require any vendors responding to the RFQ to leverage the developed part 110 from the corresponding vendor 130 when resolving dependencies in their own quote. This is discussed in more detail below.

It is noted that while the general discussion provided herein is in terms of requests for quotes (RFQs), the method may be applied similarly using requests for proposals (RFPs) and in some cases, requests for tender. In the case of an RFP, a vender may be provided with additional latitude to propose specifications or modifications to existing specifications, while a request for tender may specify everything, including a price, and a vendor receiving such a request for tender may respond by simply indicating if the proposed specifications and price are acceptable.

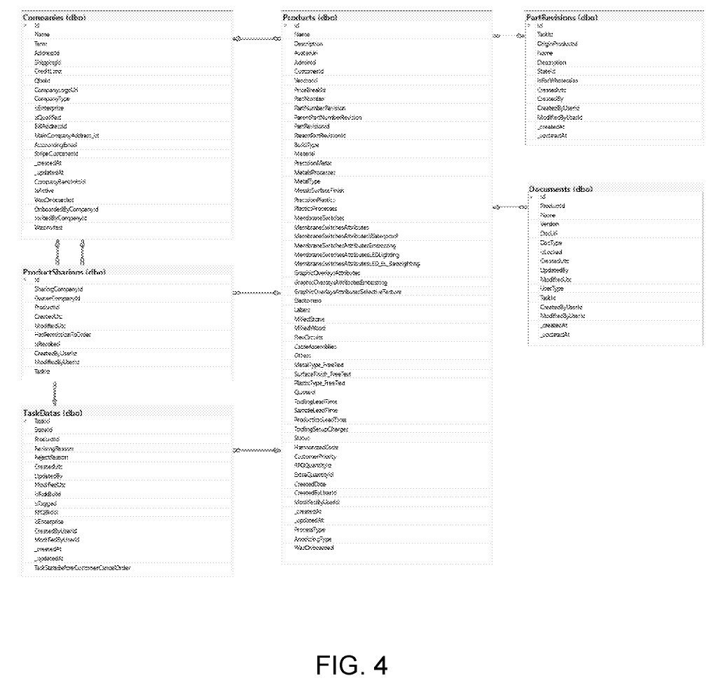

FIG. 4 shows a database diagram for providing permissioning functionality in accordance with this disclosure. As shown, a product sharing module may be associated with various products and vendors, and may control permissioning of task data associated with shared products.

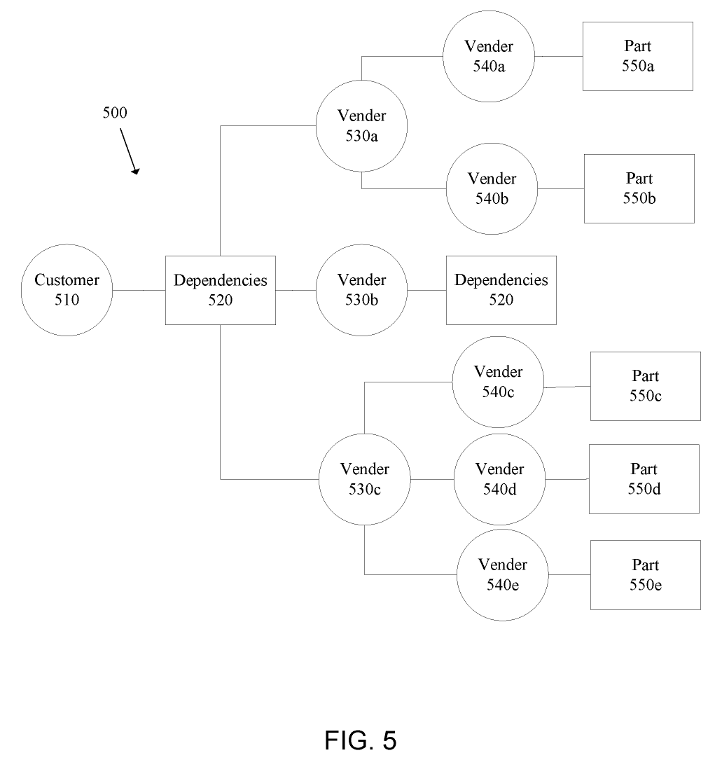

FIG. 5 is a sample production map 500 for manufacturing a part in accordance with this disclosure. As shown, a customer 510 may identify a number of products to be produced by issuing corresponding RFQs for dependencies 520. As noted above, while RFQs are discussed here, any form of part request may be used, including RFPs and requests for tender. Dependencies 520 generally describe a part, process or assembly needed to deliver a completed part or assembly.

In some cases, the customer 510 may seek a vendor to prepare a complete product, and may therefore only identify a single “dependency,” which in that case would be the completed product. In such a case, the customer 510 may issue a single RFQ, and a vendor 530a-c responding to such an RFQ may then identify underlying dependencies 520. However, in the example shown, the customer 510 has identified multiple dependencies 520. This may be, for example, when the customer 510 is completing final assembly internally, such as when the customer is itself a manufacturer.

The system 220 discussed above may process the dependencies 520 identified by the customer 510 and may generate corresponding RFQs. The RFQs may take the form of a template to be completed by the customer, or may be fully automated based on the particular dependency identified. These created RFQs may then be distributed to various first tier vendors 530a-c.

The first tier vendors 530a-c may be able to provide some services required by the received RFQs, but may have further dependencies that must be resolved. In the production map 500 shown, certain vendors 530a, c have resolved all dependencies, and are thereby linked to second tier vendors 540a-e. Each second tier vendor 540a-e may then be responsible for a single corresponding part 550a-e which may be delivered to the corresponding first tier vendor 530a, c. Other vendors 530b continue to have unresolved dependencies 520 in the production map 500.

While this description of the production map 500 assumes that products from all of vendors 530a-c are required to complete the customer’s 510 product, a related case may be a customer 510 having a single product requirement and issuing multiple RFQs taking the form of dependencies 520 to alternative first tier vendors 530a-c.

In such a scenario, each first tier vendor 530a-c may provide a bid in response to a received RFQ. As such, bids from first tier vendors 520a, c may have all dependencies resolved, and may therefore be able to provide a complete bid in response to the RFQ from the customer 510. In contrast, the first tier vendor 520b may provide a bid containing several unresolved dependencies 520. As discussed in more detail below, the unresolved dependencies may be estimated by the vendor 520b, may be drawn from a database of publicly available products or services 250, or may be satisfied using a part manufacturing template provided by the customer 510. In some embodiments, a vendor 530a-c may fully resolve all dependencies by preemptively issuing RFQs to second tier vendors 540a-e.

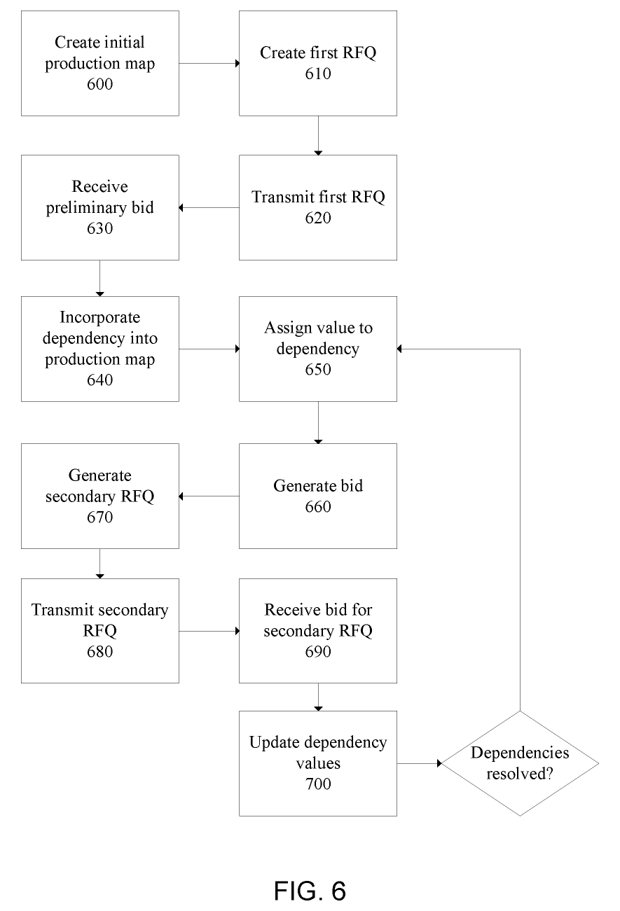

FIG. 6 is a flowchart illustrating a method for resolving manufacturing dependencies in accordance with this disclosure.

As shown, the system 200 initially creates an initial production map (600) for a primary part, process, or assembly.

The initial production map, created at 600, may simply be an initial indication of the primary part, process, or assembly, along with details required to generate a corresponding RFQ. The system 200 then generates a first RFQ for the corresponding part, process, or assembly (610) and transmits the RFQ to at least one vendor company 530a-c (620). The vendor company 530a-c may be selected by a customer 510 initiating the process, or it may be selected by the system 200 itself. In some embodiments, the system 200 may propose several appropriate vendor companies 530a-c, and the customer 510 may then choose one or more of the proposed companies to receive RFQs.

After transmitting the first RFQ to at least one vendor company 530a-c (at 620), the system may then receive, from the at least one vendor company, a preliminary bid for the first RFQ (630). The bid specifies at least one dependency 520, the at least one dependency comprising a secondary part, process, or assembly, not to be provided by the at least one vendor company 530a-c. The dependencies identified in the bid may be resolved, in that they may be assigned to a second tier vendor 540a-e, or they may be unresolved, and may require additional RFQs, or additional content in order to complete the production map 500.

While generally discussed in terms of manufacturing parts for ease of understanding, the primary part or any given dependency may require completion of a process or provision of a complete assembly. For example, the dependency may be for a sub-assembly, or creating raw material required for a part, such as a required extrusion. It may similarly be for machining, coating, or anodizing a part. It may similarly be the preparation of circuit boards, such as PCBs, required for preparing chips for a subassembly.

All dependencies 520 identified in any bids received in response to the first RFQ are then incorporated (640) into the production map 500. A value is then assigned (650) to all dependencies. In cases where dependencies are resolved, such a value may be drawn from an actual second tier vendor 540a-e engaged as part of the initial RFQ to complete the work. Where dependencies are not resolved, a vendor 530a-c submitting a bid may apply a value based on their own expertise. In some embodiments, the vendor 530a-c may satisfy a dependency 520 using a publicly available part listed in a parts database 250. In other embodiments, the system 200 may provide an estimated value. In yet other embodiments, a value for the dependency 520 may be drawn from a part manufacturing template provided by the customer 510 and requiring the vendors 530a-c to utilize a predefined vendor for such a dependency.

After values are assigned for all dependencies 520, the system 200 generates a bid (660) on behalf of the vendor 530a-c including the value of the at least one dependency, whether that dependency has been resolved or not.

Upon acceptance of a bid generated in this fashion by a customer 510, the system 200 may proceed to generate secondary RFQs associated with each dependency that has not yet been resolved (670). The system 200 then transmits (680) the secondary RFQ to at least one additional vendor company 540a-e, and receives (690), from each such additional vendor company, a bid for the secondary RFQ.

After receiving bids for each secondary RFQ (at 690), the system 200 incorporates details associated with the corresponding bids into the production map 500 and replaces (700) any values previously assigned to the corresponding dependency with a value drawn from the bid corresponding to the secondary RFQ.

It is noted that while values for dependencies may be updated, and details associated with that portion of the supply chain may be updated, a bid previously generated in response to the first part may remain valid after replacing the value previously assigned to the dependency. Accordingly, a bid generated with unresolved dependencies would typically remain valid. Alternatively, in some embodiments, a bid generated earlier may be invalidated if a value for a dependency changes by more than a threshold amount. Accordingly, if a dependency changes a bid drastically, a vendor may have an opportunity to update the corresponding bid.

In some embodiments, the bids responsive to the secondary RFQs may include at least one secondary dependency which would require a tertiary part, process, or assembly, to resolve. The method would then return to step 640 to incorporate details of the required tertiary part, process, or assembly, and to assign values for all secondary dependencies (at 650) and generate a bid (at 660) responsive to the secondary RFQ incorporating the values assigned to any secondary dependencies

Tertiary RFQs are then generated (at 670) for any unresolved dependencies, and are transmitted (at 680) to additional vendor companies. This process repeats until bids are received without any further dependencies.

In some embodiments, where values drawn from a database of publicly available options for parts, processes, or assemblies, may be assigned to dependencies, such values and the corresponding parts may be selected by a vendor 530a-c, 540a-e in order to satisfy unresolved dependencies. In other embodiments, a value drawn from the database of publicly available options may be automatically incorporated into the production map where parameters of the dependency correspond to parameters associated with the value in a database record.

In some embodiments, as discussed above, the RFQ issued by, or on behalf of, the customer 510 (at 610) may identify a provider for a secondary part, process, or assembly required for manufacturing the primary part, process, or assembly. In such a scenario, at least one of the dependencies 520 is resolved by the provider of the secondary part, process, or assembly.

In some such scenarios, the secondary part, process, or assembly is specified in a part manufacturing template, the part manufacturing template defining the provider for the secondary part, process, or assembly. The RFQ issued (at 610), may then include permissions to be granted to the at least one vendor company to order the secondary part, process, or assembly from the provider based on the part manufacturing template. Details associated with the part manufacturing template may then be automatically incorporated into the production map 500.

While such permissioning is described in the context of the customer 510, it will be understood that first tier vendors 530a-c may themselves have secondary parts that they have developed for inclusion into parts manufactured by third tier vendors 540a-b. As such, RFQs issued by first tier vendors 530a-c may similarly include permissions for corresponding part manufacturing templates, and may be used to resolve upstream dependencies.

In some embodiments, permissions for the part manufacturing template are granted only upon acceptance of a bid in response to an RFQ.

In some embodiments, different parties associated with manufacturing may have different viewing permissions for the production map 500 developed in accordance with the method described. As such, the production map typically identifies the primary part, process or assembly, at least one dependency of a first bid comprising a secondary part, process, or assembly, and at least one secondary dependency included in a bid for a secondary RFQ associated with the secondary part, process, or assembly, where the secondary dependency comprises a tertiary part, process, or assembly.

A party associated with the first RFQ, such as the customer 510, may have access to all contents of the production map 500, while a vendor 530a-c associated with first RFQ has access to the secondary part, process, or assembly and the tertiary part, process, or assembly. In other words, the vendor 530a-c has access to upstream portions of the production map 500.

Similarly, a secondary vendor 540a-e has access to the tertiary part, process, or assembly 550a-e, but not the secondary part, process, or assembly downstream from their own position in the production map 500.

In some embodiments, the production map 500 may define a primary part, process, or assembly, provided by the at least one vendor company 530a-c, and at least one secondary part, process, or assembly, provided by a secondary vendor 540a-e different than the at least one vendor company. In such an embodiment, the secondary vendor may fail to provide the secondary part, process, or assembly. Upon receiving an indication, at the system 200, that the secondary vendor 540a-e has failed to deliver, and cannot provide the secondary part, process, or assembly, the system may generate a new secondary RFQ for the secondary part, process or assembly, and transmit the secondary RFQ to a tertiary vendor. This allows the system 200 to repair a broken supply chain using the production map 500.

As discussed above, although discussed in terms of RFQs in this disclosure, the part requests may take the form of RFQs, RFPs, or offers for tender. In some embodiments, in a failover scenario, the initial part requests may be RFQs, while the request generated when the supply chain breaks may be a request for tender. As such, when the supply chain breaks, a request may go out to multiple venders asking which are willing to fulfill the order with proposed specifications at a proposed price.

In some embodiments, the production map 500 may define at least one tertiary vendor capable of providing the at least one secondary part, process, or assembly as a backup vendor. In such a scenario, upon receiving an indication that the secondary vendor 540a-e cannot or will not provide the secondary part, process, or assembly, the system 200 can replace the secondary vendor 540a-e with the tertiary vendor in the created production map 500 so as to minimize downtime during a changeover.

This potential redundancy and failover mapping can reduce downtime by having backup options ready to be slotted in during manufacturing of sophisticated products.

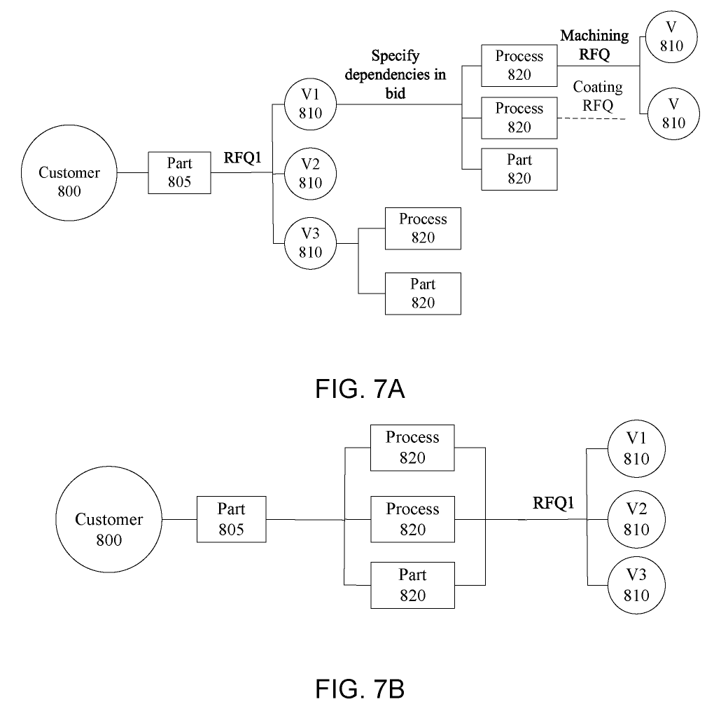

FIG. 7A illustrates an RFQ graph illustrating an ASK process, in accordance with this disclosure. During an ASK type RFQ process, a customer 800 may request a bid for a part 805. An RFQ may then be distributed for the same part to three distinct prospective suppliers, or vendors 810. The vendors 810 must then declare the number of dependencies 820, including outside processes or parts, that will be leveraged to complete their manufacturing solution. Those will be entered as unsolved dependencies 820 which must be sourced and managed by the system if that particular vendor win the project assignment. Fewer dependencies 820 typically mean that the vendor 810 can get more done in house. In the example shown, vender 810 V1 has three unsolved dependencies 820 that must be resolved, which results in two RFQs for processes (in this case machining and coating) and one RFQ for a part.

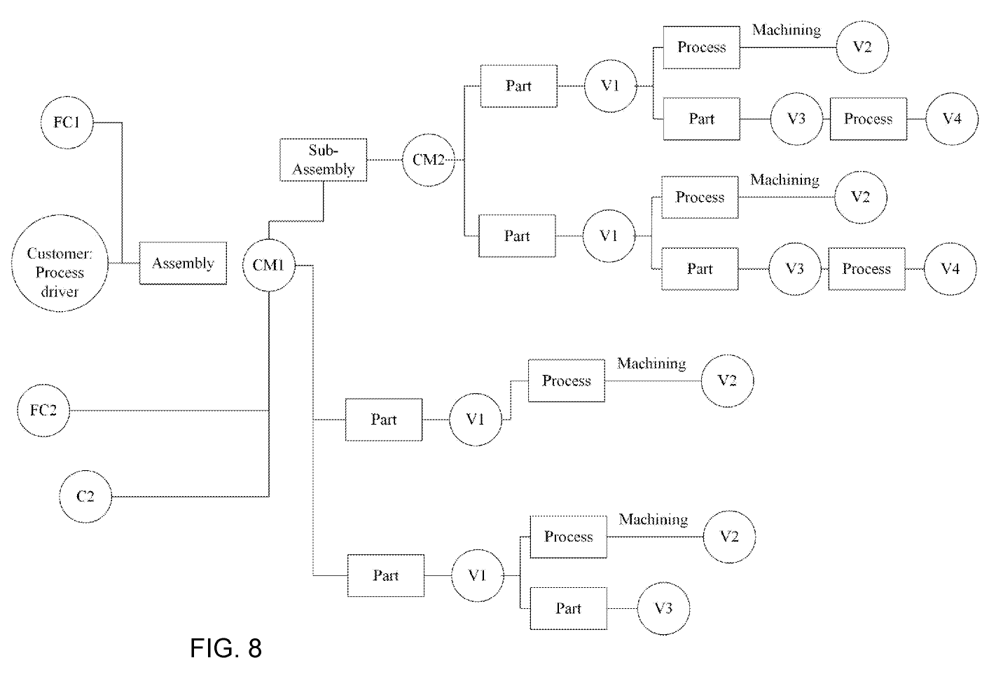

This ask process repeats until no outside processes or sub parts are found. In the case of a complex extruded and machined part, such as that shown in FIG. 8, there may be multiple sub processes upstream of a machine shop. For example, a part may require an extrusion house, and an anodizing house. The system may also generates share instances using the methods described above with respect to FIG. 4 in order to grant the process owner access to buy the raw extrusion and anodizing jobs so they can be maintained in the event that a particular vendor is removed from the supply chain.

FIG. 7B illustrates an RFQ graph illustrating a TELL process, in accordance with this disclosure. When looking for assemblers or integrators under the TELL method, it is necessary to provide all potential vendors with a BOM driven list of custom and already sourced components that they must source from already arranged suppliers. This may be a vendor 140 specified in a part manufacturing template, as in the scenarios discussed above.

In such a scenario, a part request from a potential vendor, such as an RFQ, may identify the vendor for a secondary part, process, or assembly, necessary to resolve a dependency in the supply chain. When developing the production map discussed above, this dependency is then resolved by the vendor specified in the initial part request. This specification may take the form of a part manufacturing template, such as that discussed above, which would then define the provider. The RFQ may then include permissions to be granted to the potential vendor to allow them to order the secondary part, process, or assembly from the provider based on the part manufacturing template. In such a scenario, details associated with the part manufacturing template are then incorporated into the production map.

In some embodiments, when the part manufacturing template is incorporated into an RFQ, information required to formulate the rest of the vendor’s bid may be provided with it. Additional access may then be withheld initially, and provided once a bid from that vendor is accepted. The dependencies of the parts to the assembly are then generated along with the shares, completing the map of the network down to the end of the "ask" chains.

FIG. 8 shows a more complex order, in accordance with this disclosure. As shown, the ASK and TELL methods can be repeated until a complete production map is developed for a supply chain.

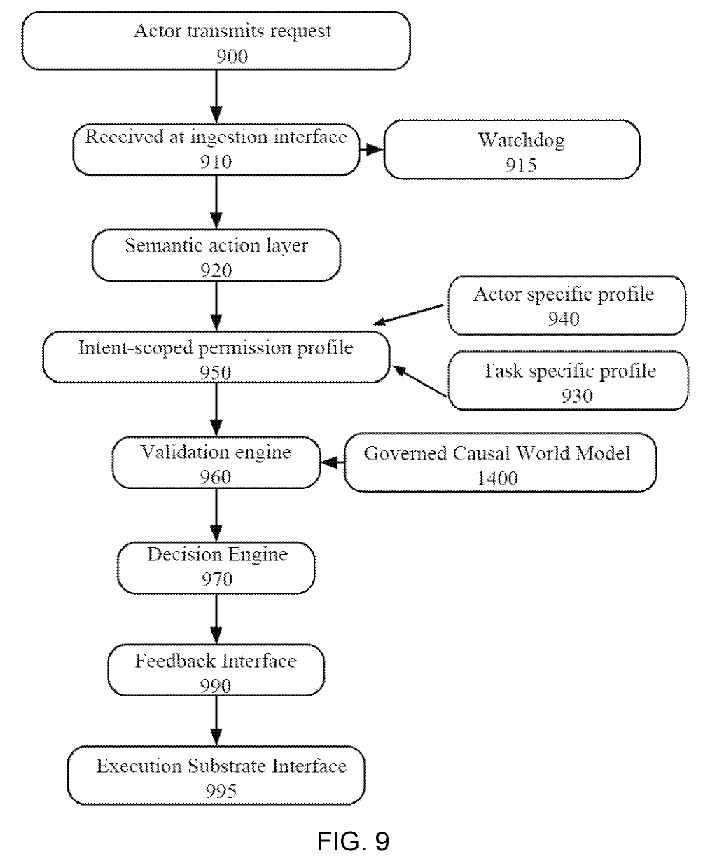

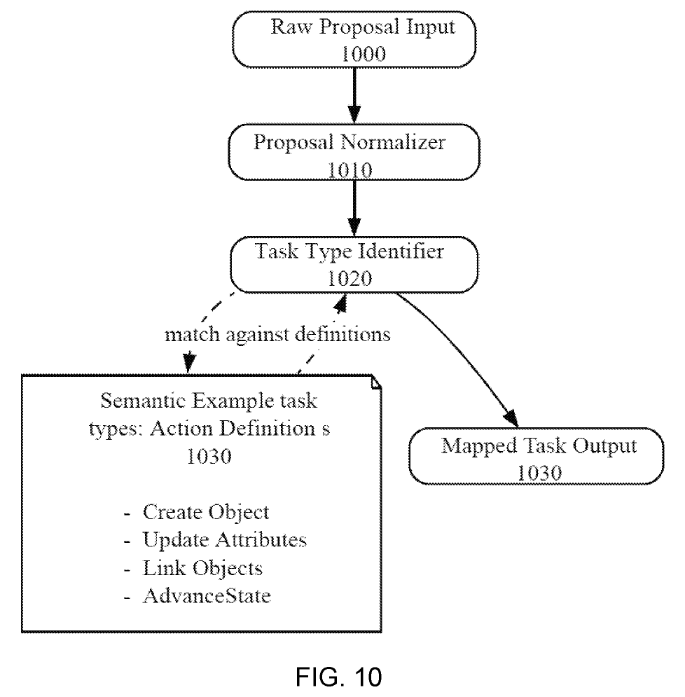

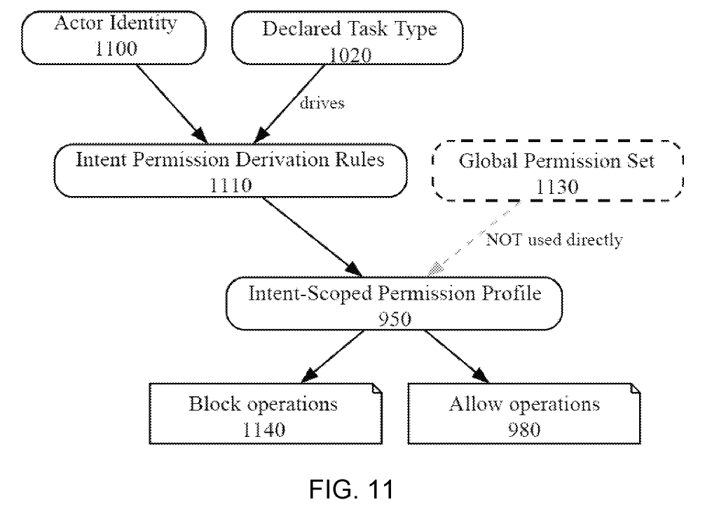

FIG. 9 is a flowchart illustrating a gateway architecture for determining whether a request to implement a state transition is to be executed. FIG. 10 is a method for semantically mapping a request to implement a state transition in the context of the gateway architecture of FIG. 9. FIG. 11 is a method for defining an instance-specific authority profile in the context of the gateway architecture of FIG. 9.

As discussed in detail above, modern enterprise systems lack a shared execution state across internal systems as well as across organizational boundaries. Accordingly, the physical economy operates through independent interpretations of operational events. Each organization, or even system or subsystem within a single organization, therefore maintains its own systems record, which may include internal ERP platforms, CRM systems, financial ledgers, inventory systems, logistics platforms, quality management systems, and product lifecycle tools, as well as other systems. Each such system may then maintain a local interpretation of an operational state based on transactions it observes.

Documentation within such systems therefore represents snapshots of operational belief at a specific point in time. As executions of tasks are implemented, these snapshots represented by documents are quickly outdated and real world states diverge from such internal representations. However, systems, either alone or in concert, must be able to execute tasks based on some shared belief.

The methods described may be implemented in combination with the graph-based modeling of interdependent relationships described above in the context of manufacturing. Such models can include template-driven production definitions and delegated permission structures across multiple parties. The methods described may then function at a different architectural level, governing how actions enter the system through semantic interpretation, intent-scoped authorization, and governed causal validation. Additional methods govern how approved actions are executed through configuration-defined domain models and deterministic causally consistent state transitions.

Accordingly, a computer-implemented method for governing execution of tasks is provided, such that the method provides a validation gateway for determining whether a request to implement a state transition is to be executed. In this way, the systems and methods described determine whether proposed state transitions are permitted to come into existence as binding operational state prior to execution within an operational environment. States, as discussed herein, typically refer to a defined lifecycle condition of an object. States determine which transitions are permissible and which constraints or dependencies apply. States may be defined externally in configuration files. Where a governed causal world model is used, transitions moving objects from one state to another or modifying governed relationships or attributes must satisfy rules defined in the governed causal world model.

A sequence or directed graph of permissible transitions through which an object may progress can be referred to as a workflow, discussed in some embodiments below. Such workflows may be defined externally in configuration files and may include approvals, dependencies, and branching logic as well as terminal states.

Such a method initially receives when an actor transmits (900) a request to implement some state transition within a system which is then received at a computer system (910). The request received (910) is to implement a state transition which would, if executed, trigger a real-world effect.

In the implementations described, the actor transmitting the request (at 900) could be any entity capable of submitting proposals. Such actors may be human employees of an entity, or it could be autonomous agents, other human users, software systems, or devices. Actors do not directly write to governed state, since, as described, all transitions must pass through the execution gateway. Proposals are structured requests to perform a semantic action in a governed object. A typical proposal includes actor identity, declared task type, referenced objects, and proposed data.

Examples of such a real-world effect could be, for example, a creation of a legally binding agreement between entities, a release of physical goods for shipment, a financial transaction, such as issuance of a refund, credit, or payment, or a memory based transition, such as a write or delete operation performed against persistent storage. A wide variety of other potential state transitions are contemplated as well. Many such transactions are irreversible or very difficult to reverse, and many such transactions propagate across multiple entities and/or departments within entities.

The method then proceeds to identify, in the request, a declared task type (920) associated with the proposed state transition at a semantic action layer. Once a declared task type is identified (at 920), the method derives a task-specific authority profile (930) based at least partially on the declared task type. The task-specific authority profile comprises a plurality of discrete required permission levels to execute a task of the declared task type. Such a permission profile is then intent-scoped, in the sense that the set of required permissions is derived from the declared intent, or declared semantic purpose of the underlying proposal, and limits permissible operations to those associated with the specific task type.

Such an authority profile may thereby indicate that in order to execute the proposed state transition, the actor transmitting the request must have at least a certain level of authority in each of several different areas. As such, the areas in which authority is required may be defined granularly.

Accordingly, as illustrated in FIG. 11, once the task-specific authority profile (derived at 930) is derived from the declared task type (output at 1030), an actor-specific authority profile is determined (940) based on the actor 1100 from whom or which the request was received (at 910). The actor-specific authority profile is based on the actor who transmitted the request (at 900) and defines an actor-specific permission level associated with each of the discrete permissions of the task-specific authority profile (at 930). Accordingly, the actor-specific permission levels are typically defined at least as granularly as the task-specific authority profile.

Once the task-specific authority profile and actor-specific authority profile are known, the method proceeds to create an instance specific authority profile (950) following intent permission derivation rules (at 1110). The instance-specific authority profile, once created, comprises at least one category of permissions corresponding to a category defined in each of the task-specific authority profile (at 930) and actor-specific authority profile (at 940).

The corresponding permission of the instance-specific authority profile (at 950) is then defined to correspond to the narrower of the corresponding task-specific permission level and the actor-specific permission level.

In this manner, for each requested state transition, a unique instance-specific authority profile is created (at 950) with a granular set of permissions corresponding to the least permissive of each of the actor originating the request (at 900) and the task type associated with the requested transition (at 920). Such a profile may also be referred to as an “intent-scoped” permission profile (950). Accordingly, if a transition requested triggers a further unexpected change outside of the scope of the original task, such a change could prevent the task from executing even if the actor is otherwise authorized to implement the change. A global permission set (1130) may be used to inform limits of a potential intent-scoped permission profile (950) but typically would not be implicated and is optional. Accordingly, intent-scoped permission profile may enforce that an actor may only perform operations meaningful to the declared intent.

The permission profiles discussed herein may define, for example, permissible attribute modifications, allowable relationship changes, whether object creation is permitted, whether state advancement is allowed, and which validation rules apply.

Accordingly, in some embodiments, the actor-specific authority profile (at 940) defines at least one actor-specific permission level broader than a corresponding required permission level of the discrete required permission level. The resulting instance-specific authority profile then comprises an instance-specific permission level narrower than the at least one actor-specific permission level.

Following the creation of an instance-specific authority profile (at 950), the method may proceed to validate the proposed state transition (960) by way of a validation engine. Such validation may include several steps and will typically include determining whether the created instance-specific authority profile (at 950) defines sufficient permissions for each discrete required permission level. Accordingly, based on the intent-scoped permission profile (at 950), the method may proceed to block operations (at 1140) or allow the operations (at 980). Alternatively, the method may separate the intent-scoped permissioning (at 950) from validation (at 960) and may proceed to validate the transition only after confirming that permissions are validated.

Accordingly, the method then utilizes a decision engine (970) to authorize implementation (980) of the state transition requested (at 900) only upon validating the proposed state transition (at 960) and determining that the created instance-specific authority profile (at 950) defines sufficient permissions for each discrete required permission level. Once the proposed state transition is determined to be admissible, the method may hand off the requested transition (at 900) to an execution interface or engine 995.

Such an execution interface may be a separate engine than the gateway described herein for authorizing the requested transition, and is discussed in more detail below. Once a transition is admitted, its consequences can propagate at machine speed across dependent execution objects.

FIG. 10 illustrates an approach to identifying the derived task type (at 920) using an ingestion interface. Accordingly, upon receiving the request to implement a state transition (at 910), the method hands off the request to the ingestion interface which may first receive the raw input (1000) and normalize an incoming proposal (1010) prior to identifying the declared task type (at 920). A task type identifier (1020) may then receive the normalized proposal and the identification may be based on semantically mapping the normalized request to one or more predefined task type (at 1030).

The request to implement a state transition (received at 910) may then comprise sufficient information to define the state transition and the source. For example, the request (at 1000) may include an identity and/or credentials of a source of the request, a semantic action, semantic intent, or task type declaration, an object reference, and at least one proposed attribute value or modification. Normalization (at 1010) may then include parsing structured or semi-structured inputs, extracting referenced objects, validating minimal schema compliance, and mapping values to canonical fields. In this way, all proposals may be normalized into a canonical representation, allowing the gateway to operate consistently regardless of the proposal’s source or original format.

Operations are typically performed on "objects" in the context of the systems described. Accordingly, an object is a governed data entity represented within the system. Objects are instantiated from configuration-defined schemas, as discussed below, and possess attributes, relationships, and lifecycle states. Execution events operate on a set of underlying execution objects representing the entities involved in operational work. For example, in the context of a proposed state transition representing shipment of a product, the objects may include:
a. transaction commitments;
b. inventory state;
c. logistics movements;
d. quality conditions;
e. regulatory certifications;
f. provenance records;
g. contractual obligations; and
h. financial liabilities.

The semantic action or defined task type is then a coarse-grained domain-agnostic representation of the intended operation, such as creating, updating, associating, evaluating, or advancing an object. Such semantic actions may define an allowable action space that abstracts away low-level operations. Such defined task types, such as “create object,” “update attributes,” “link objects,” or “advancestate” may then each have known requirements and repercussions, and may then have a predefined task-specific authority profile (at 930). Accordingly, once mapped, the task type identifier (at 1020) may proceed to output the mapped task type (at 1030) so that the method discussed above may proceed accordingly. The discrete required permission levels are then defined based on the one or more predefined task type output by the semantic action layer (920).

In some embodiments, at the time of receipt of the request (at 910), the request may be received at a proposal ingestion interface monitored by a watchdog or loop detection module 915. Such a watchdog mechanism may be a monitoring mechanism that detects repetitive, cyclic, or unresolved proposal patterns. Accordingly, the watchdog 915 may maintain a proposal sequence log and may detect similarity across requests (received at 910). If a loop is detected, it may be recorded and typically rejected. When such problems persist, the watchdog 915 may trigger escalation which may implicate, for example, human oversight. Accordingly, the watchdog 915 may identify situations where repeated proposals fail consistently, reproduce similar validation errors, or cycle between similar states due to multi-agent interactions. When thresholds are met, the transition is escalated to a governed human role, further automated processing may be paused, and diagnostic information is recorded. This approach prevents autonomous agents from entering uncontrolled feedback loops.

As noted above, the instance-specific authority profile defined based on the semantic mapping may be narrower than the actor-specific authority profile. This may result in allowing an automated process or agent to make some modifications necessary for the defined task but not others. As one example, the semantic action may require modification of one field of a plurality of fields but does not require modification of a second field of the plurality of fields. The actor, on the other hand, may have an actor-specific authority profile defining a permission level sufficient to modify both he first and second field of the plurality of fields. In such a scenario, the instance-specific permission level may authorize modification of the first field but not the second field of the plurality of fields, despite the fact that the actor would otherwise be free to make additional changes.

In some embodiments, the discrete required permission levels may include at least one variable permission level. For example, where a state change requested corresponds to ordering some product, a discrete required permission level may indicate that such ordering be authorized but may be limited or unlimited. Such limitations may be, for example, by quantity of the product to be ordered or by total cost of the order. In such a scenario, the resulting instance-specific authority profile then contains a corresponding instance-specific permission level based on the corresponding actor-specific permission level upon determining that the actor-specific permission level is within a range of the variable permission level. Accordingly, if the task requires ordering product and the actor is authorized to order that product up to a certain amount, the corresponding task-specific permission would be similarly limited.

In some embodiments, the identity of the source of the request (at 900) identifies two actors having different actor-specific authority profiles (at 940). A resulting actor-specific authority profile includes a highest permission level associated with one of the corresponding actors for each of the actor-specific permission levels. Such a scenario is discussed in more detail below in the context of a proposed state change that would propagate changes across two distinct entities.

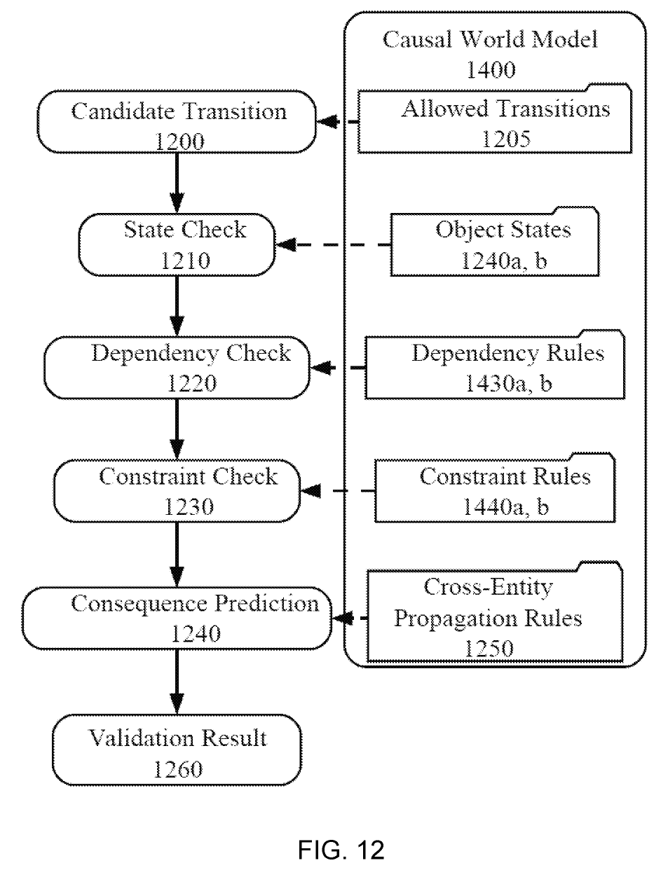

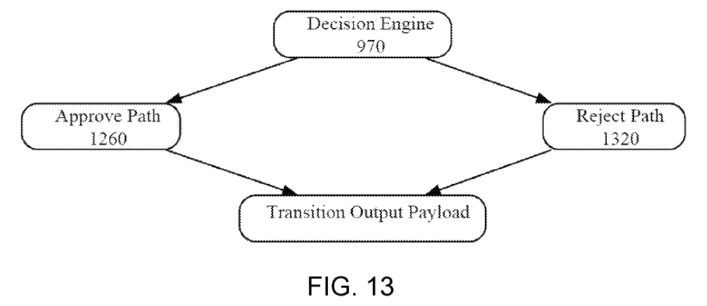

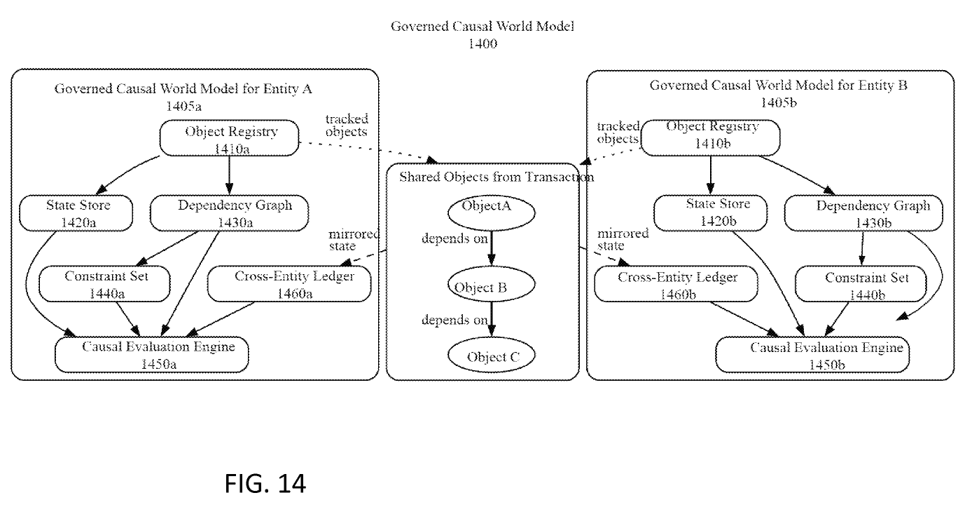

FIG. 12 illustrates a validation pipeline for use in the context of the gateway architecture of FIG. 9. FIG. 13 illustrates potential executable decisions generated by the gateway architecture of FIG. 9. FIG. 14 illustrates a governed causal world model for use in the validation pipeline of FIG. 12.

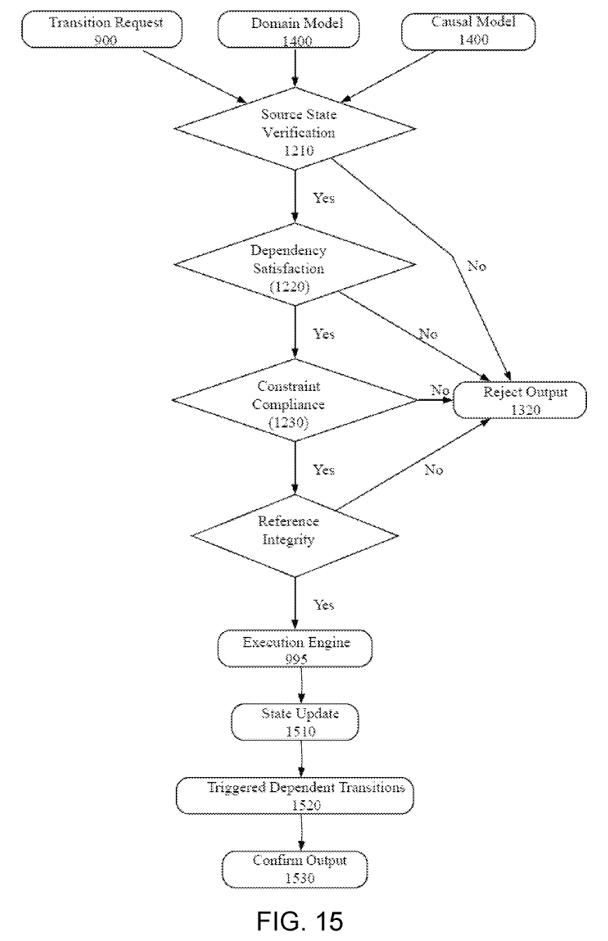

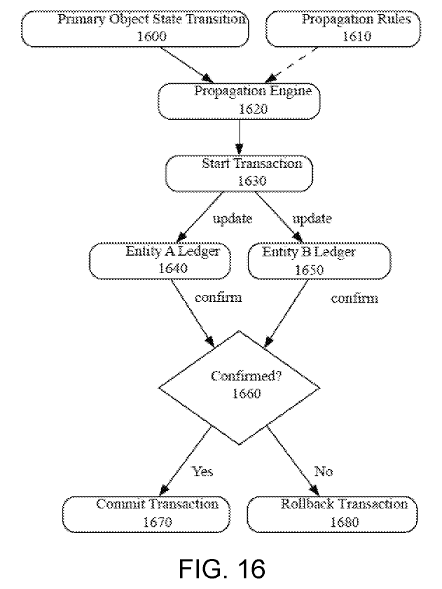

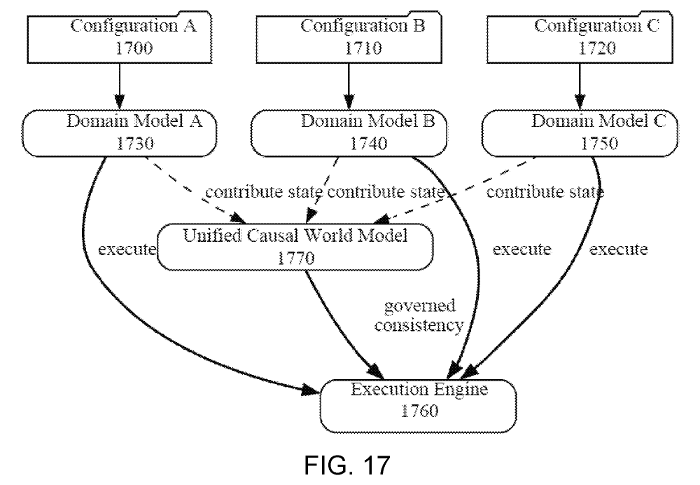

FIG. 15 illustrates validation of a requested state transition in the context of a governed causal world model. FIG. 16 illustrates a validation check in accordance with this disclosure propagated across multiple entities. FIG. 17 illustrates the execution of the proposed state transition upon confirming validation across the governed causal world model.

As discussed above, following the creation of an instance-specific authority profile (at 950), the method proceeds to validate the proposed state transition (at 960). Such validation may include the permissions validation, but may also include more general validation (970) of the requested state transition (at 910) against a governed causal world model (1400). Such a governed causal world model is a representation of all governed objects, their states, allowed transitions between states, dependency relationships among objects, required approvals, constraints, and conditions, and cross-entity propagation rules. The causal world model may then enforce consistency and determine validity of proposed transitions. The world model then serves as the authoritative source of truth and determines the validity of any proposed transition. Constraints within the governed causal world model are logical rules that govern whether a transition is permitted. Constraints may include required field values, cardinality rules, sequencing requirements, inter-object dependencies, or approval conditions. Dependencies represent a defined relationship between objects or transitions that specifies prerequisite conditions for state changes. Dependencies may span multiple objects or entities.

The governed causal world model 1400 then may include hierarchical dependencies (e.g., parent/child object relationships), temporal rules (e.g., sequencing constraints), conditional expressions (e.g., required values), multi-entity agreements (e.g., mirrored transitions). The gateway discussed interacts with the causal world model 1400 but does not modify it directly. Instead, the gateway uses the model to validate proposed transitions and any modification is applied only after successful validation and decision processing.

Such validation against a causal world model is demonstrated in more detail in FIG. 12, and an example of such a causal world model is illustrated in FIG. 14. Examples of modeling execution of a state transition in such a causal world model may be represented in a causal execution graph, such as the those illustrated above in FIGS. 7A, 7B, and 8, among others, which could support execution of the method described herein in the context of a manufacturing process. The validation check shown in FIG. 12 may be implemented by a validation engine (at 960), which evaluates proposals against the governed causal world model 1400 by checking various constraints.

It is further understood that while several examples illustrate use of a graph database in the context of manufacturing, the method may be implemented using broader implementations of governed causal world models, so long as a set of rules governing a transition can be considered.

The method is not tied to a specific industry context or a particular database implementation. The more important consideration is that the system on which the method is implemented requires a relationship-native, dependency-aware, permissioned state model that governs how state is formed, validated, and shared across entities, or across systems or groups within an entity.

With this in mind, as shown in FIG. 12 and 14, the governed causal world model 1400 may be provided for multiple entities 1405a, b, and each such entity then includes an object registry 1410a, b, current state data for those objects 1420a, b, dependency requirements, which may be presented or stored as a dependency graph 1430a, b. The model may further include a constraint set 1440a, b, as well as an internal causal evaluation engine 1450a, b. Where multiple entities are modeled 1405a, b, each entity may also have a cross-entity ledger 1460a, b for supporting the internal causal evaluation engine 1450a, b in evaluating cross entity propagation rules.

Accordingly, a set of shared objects 1470a, b, c and their corresponding dependencies may be modeled by drawing on tracked objects from the object registries 1410a, b of each underlying entity 1405a, b and mirroring the hypothetical results of the requested state transition (910) into each cross entity ledger 1460a, b for evaluation.

In any event, the governed causal world model typically comprises a current state (1420a, b) of every governed object (1410a, b), relationships and dependencies among those objects (1430), and cross-entity state mappings.

In the context of such a governed causal world model 1400, the evaluation of the requested state transition (910) against the governed causal world model 1400 can proceed by evaluating a candidate transition (1200) at a validation engine (960) against allowed transitions 1205 as defined by the causal world model 1400. The method may then proceed to evaluate the hypothetical candidate transition by performing a state check (1210) or state validation against the current state data for all objects 1420a, b. Such a state validation (at 1210) confirms that the proposed transition is allowed form the objects current state. The state validation (at 1210) may be followed by a dependency check (1220) or dependency validation against the dependency requirements (1430a, b) of the model 1400. Such dependency validation (at 1220) ensures that related objects satisfy prerequisites, such as required predecessor states, mandatory linked object existence, and dependency conditions across objects.

The method then proceeds to perform a constraint check (1230) or constraint validation against the constraint set 1440a, b. such a constraint validation (at 1230) includes checking logical rules such as field requirements, cardinality constraints, ordering requirements, and conditional expressions defined in configuration.

Finally, the validation engine (at 960) proceeds to predict or evaluate consequences (1240) of implementing the proposed state transition, which may be based on cross-entity propagation rules (1250) embedded in the cross-entity ledger 1460a, b or elsewhere in the model. The consequence evaluation (at 1240) may include predicting downstream effects on dependent objects or entities, ensuring no rule violations occur if the transition is executed. The consequence evaluation (at 1240) may also include checking reference integrity, verifying that all referenced objects exist, are accessible, and are in allowable states.

Such a sequence of checks 1200, 1210, 1220, 1230, 1240 may be implemented by the method on an external evaluation system, or it may be implemented internally within the governed causal world model by the causal evaluation engine 1450a, b. As a result, the evaluating of the requested state transition against the governed causal world model 1400 includes confirming that all object states of the hypothetical resulting transition following the candidate transition conform to allowed object states, that all dependencies of the hypothetical resulting state conform to dependency rules of the causal world model, and that all predicted consequences resulting from the hypothetical resulting state conform to cross-entity propagation rules.

As a result, the method may generate a validation result (1260) which determines whether the implementation of the state transition requested (at 910) is permitted to exist as binding operational state (at 980). Only proposals that are determined to be admissible based on evaluation of interdependent conditions proceed to the decision engine. Such a validation result may further include feedback information supporting the corresponding determination, which may be presented to a user at a feedback interface (990). Alternatively, feedback may support potential modifications, as discussed below. The feedback interface (990) may provide a structured response summarizing the decision outcome, new or pending object states, reasons for rejection or modification, required next actions, and escalation notices. Feedback helps align autonomous systems with governed truths, thereby guiding autonomous agents back towards governed behavior and prevent hallucination-driven actions and repeated invalid transition scripts.

It will be understood that in some implementations, not all of the individual checks 1200, 1210, 1220, 1230, 1240 will be necessary or relevant, or some may be combined into single steps. Further, additional validation steps may be implemented, depending on the details of the proposed state transition. Accordingly, execution events are evaluated across multiple dimensions before propagation, including:

order data integrity

causal dependencies between events

temporal constraints and sequencing

counterparty commitment validation

governance permissions through RPAN

quality state and CAPA workflows

regulatory state conditions

contractual conditions derived from legal agreements

permissioned visibility across participating organizations

cross-object reconciliation, including consistency across related order, shipment, receipt, and invoice objects.

In any event, the governed causal world model 1400 may be used to define a hypothetical resulting state following the requested state transition. The proposed state transition may be determined to be admissible (at 980) upon determining (at 1260) that the hypothetical resulting state is valid.

Typically, the hypothetical resulting state is evaluated (at 1450a, b) deterministically against a set of deterministic constraints so as to confirm required predecessor states (at 1420a, b), mandatory linked object existence (at 1430a, b), and dependency conditions (1430a, b) across multiple objects. Given the same inputs, authority, dependency state, and governing constraints at the moment of evaluation, the execution substrate will therefore always produce the same admissibility decision. Such evaluation may similarly be performed across multiple entities 1400a, b. Accordingly, evaluation against the governed causal world model 1400 includes applying deterministic validation rules to a causal execution graph, such as that discussed above with respect to FIGS. 7A, 7B, 8, where the results of the application to the causal execution graph determine whether the hypothetical resulting state is valid.

As shown in FIGS. 7A, 7B, and 8, and as further illustrated in the governed causal world model 1400 of FIG. 14, the causal execution graph may then define allowed object states, allowed object transitions, and dependency rules across a plurality of entities 1400a, b. Accordingly, the actor-specific authority profile (940) may be associated with only one of the plurality of entities (1400a), and that entity may then not have direct access to information governing the causal world model with respect to the second entity (1400b) of the plurality of entities.

Accordingly, as in the case of manufacturing delays discussed above with respect to FIGS. 7A, 7B, and 8, the use of a governed causal world model 1400 allows for the purpose driven provision or usage of limited information across entities, where those entities otherwise would not have such information. Following validation and authorization of a state transition (at 980), the method may then hand off the requested transition (900) to an execution interface or engine 995 in order to implement the corresponding transition.

One example of the described method is a general agent-initiated transition with intent-scoped permissions. An autonomous agent may submit a proposal (at 900) requesting a state transition on a governed object. The proposal identifies:
a. the actor (the agent),
b. the semantic action (the declared task type),
c. the object reference, and
d. proposed attribute values.

The method receives the proposal (at 910) and the semantic action layer maps the proposal to a predefined task type (at 920). The intent-scoped authorization engine generates a permission profile (at 930-950) that allows only those operations associated with the task. For example, the agent may read certain object attributes and update specific fields permitted for the task type but may not modify unrelated attributes or execute unrelated transitions.

The validation engine evaluates the proposed transition (at 960) against the governed causal world model 1400, ensuring:
a. the object is in a valid source state (at 1210),
b. dependencies are satisfied (at 1220),
c. constraints associated with the transition are met (at 1230), and
d. no downstream violations will occur (at 1240).

If valid, the decision engine determines that the proposed state transition is admissible (at 1260). Otherwise, in some embodiments, it rejects (1320) the proposal with structured reasons. The outcome is returned to the actor 1100 via the feedback interface, as discussed in more detail below. In some embodiments, any subsequent changes to the proposed state transition are performed by the actor 1100 only after receiving feedback.

As another example, an actor 1100 may submit a proposal (at 900) to associate a supporting object with a primary governed object. The semantic action layer identifies this as an "attachment" task type (at 920) with some restrictions. Under intent- scoped authorization, the actor may:
a. supply the supporting object,
b. read necessary identifying attributes of the primary object,
c. associate or link the objects.

However, the actor may not:
a. modify unrelated fields,
b. alter the primary object’s state,
c. delete or detach unrelated objects.

The validation engine checks:
a. whether the supporting object is compatible,
b. whether the primary object’s state allows attachment,
c. whether any dependency conditions apply.

If validated, the decision engine approves (1260) the association; otherwise, it rejects (1320) the proposal.

In another example, a multi-agent negotiation may be implemented with loop detection. Two autonomous agents may collaborate to complete a governed transition on a complex object. One agent proposes a transition (at 900) requiring additional data. The gateway rejects (1320) the transition with structured deficiency reasons. The second agent responds with a revised proposal (at 900) supplying additional information. If the information remains insufficient or contradictory, the gateway continues to determine that the proposed state transitions are non-admissible with updated deficiency reports. The watchdog mechanism (915) monitors repeated proposals.

If a sequence of proposals fails to converge after a threshold number of attempts, the watchdog:
a. classifies the pattern as a loop,
b. halts automated processing for the object, and
c. escalates the matter to a human role.

This prevents uncontrolled oscillation between autonomous agents.

In another example, as discussed above, in some embodiments, the identity of the source of the request (at 900) identifies two actors having different actor-specific authority profiles (at 940).

In such a scenario, a governed object progresses through a workflow requiring approvals from multiple roles. Each actor may then submit approval proposals (at 900) and the declared task type may then be “approval.” Accordingly, an actor associated with the first entity 1400a may contribute some required permissions while an actor associated with the second entity 1400b may contribute other required permissions, and such permissions may then propagate across both entities within the context of the governed causal world model 1400. As such, the actors may not be aware of each other or the underlying requirements, but may work together to authorize and validate a state transition.

For each proposal, the gateway:
a. verifies that the actor’s role aligns with the approval rule for the current state;
b. applies intent-scoped authorization to restrict operations to approval actions only; and
c. validates that dependencies and prior approvals have been satisfied.

When all required approvals are collected, the decision engine determines that the proposed state transition is admissible and the object advances to the next state.

Transition propagation rules may trigger additional governed actions for dependent objects. All outcomes are then recorded in the governed causal world model.

Accordingly, the two actors may be associated with two corresponding distinct entities 1400a, b, and as shown in FIG. 14, a relationship between the two distinct entities may be defined by the governed causal world model 1400 representing current state data 1420a, b and dependency requirements 1430a, b. The task-specific authority profile 960 may then define discrete required permission levels at each of the two distinct entities 1400a, b.

In an example of a complete execution, in some embodiments, implementation of the state transition (requested at 900 and received at 910) may be executed at an execution engine 995, and may trigger a creation of a legally binding agreement between the first entity 1400a and the second entity 1400b. Such a legally binding agreement may then be requested by an actor 900 at the first entity 1400a and may be automatically validated based on internal requirements associated with the second entity 1400b. Despite the fact that the actor 900 at the first entity 1400a cannot bind the second entity 1400b and does not have access to their internal validation requirements, the request may still result in such a binding agreement.

In some embodiments, in addition to or instead of permission based authorizations, across multiple entities, physical or system based validations must be confirmed. For example, the state transition requested (at 900) may be an initiation of a release of physical goods for shipment. Accordingly, implementation of the state transition at a first entity 1400a may trigger a generation of a warehouse pick instruction or carrier dispatch at a second entity 1400b. In such a scenario, the execution of the order generating the release of physical goods necessarily depends on internal warehouse systems, such as inventory systems, associated with the second entity 1400b. However, the method described may determine that the proposed state transition is admissible based on the order from an actor associated with the first entity 1400a upon validating a corresponding hypothetical state transition against the global causal world model 1400 in the context of the second entity 1400b.

It is noted that within the context of a proposed state transition representing a canonical execution event, a sequence of causal dependencies could be represented within the model. Accordingly, the initiation of a release of physical goods for shipment could be represented by a sequence including:
a. Order commitments;
b. Fulfillment events;
c. Shipment confirmations;
d. Receipt validations; and
e. Invoice eligibility.

Such a sequence may further be broken down more granularly, such that operational commitments may include RFQ, quote agreement, purchase commitment, change orders, fulfillment, shipment, receipt, invoicing, and payment.

Other scenarios may require similar validation across either one or multiple entities. For example, the requested state transition may be to initiate issuance of a refund, credit, or payment, and implementation of the state transition may then trigger transfer of funds or settlement of a payment instrument.

These events form vertices in a causal execution graph representing operational state transitions. Actors—humans, enterprise systems, devices, and AI agents—may propose events, but the graph determines whether those events are admissible. Accordingly, agents can participate in operational execution, since in this architecture, the actor does not directly commit operational state. Instead, they generate execution proposals that are evaluated through the deterministic validation model before they can become authoritative execution transitions.

Each participating organization applies the same deterministic validation rules to proposed events, allowing the execution graph to behave like a replicated state machine where organizations act as network nodes and operational commitments become state transitions.

Data systems determine meaning through semantic mappings—rules that translate concepts into queries and interpretations.

Execution systems require a different form of mapping: rules that determine whether proposed actions are admissible.

In the causal execution model, proposed operational commitments are mapped to deterministic state transitions only when operational, governance, contractual, and regulatory conditions are satisfied.

One example of the architecture supporting this implementation is discussed above in reference to a supply chain implementation allowing propagation across organizations in the context of a multi-tier supply chain, thereby coordinating customers and suppliers under a shared execution state.

While this additional detail is provided in the context of releasing goods for shipment, a wide variety of proposed state transitions are contemplated. Accordingly, the state transition may be to initiate a write or delete operation against persistent storage, such that implementation of the state transition triggers irreversible modification or destruction of stored data.

In some embodiments, where the method determines that the hypothetical resulting state is invalid (at 970), such that implementation cannot be authorized (at 980), the method proceeds to attempt to cure the implementation, as shown in FIG. 13. Accordingly, if the transition complies with all rules, it will be approved, or authorized (at 980). If the validation result (at 1260) indicates a failure to validate the method may modify (1300) the proposed transition. This may be, for example, by identifying a modification, such as adjusting certain fields or normalizing data, that preserves the semantic intent of the underlying requested transition. Such intent may then be the declared semantic purpose of a proposal. In such a scenario, the method may incorporate the modification into the requested transition and return the modified requested transition to the validation engine (at 960) to reevaluate the requested state transition.

In some embodiments, where no acceptable modification can be identified, the method may determine that the requested transition (at 900) is not inherently invalid, but that it requires additional approvals or dependencies that must be satisfied prior to transition execution.

Finally, in some embodiments, validation fails (at 970) without attempting to salvage the requested transition (at 900). In such a scenario, the method may reject (1320) the transition based on violations or inconsistencies preventing execution.

The output of the decision or validation engine (960) may then include required next steps, supplemental instructions, and/or clarification of information deficiencies.

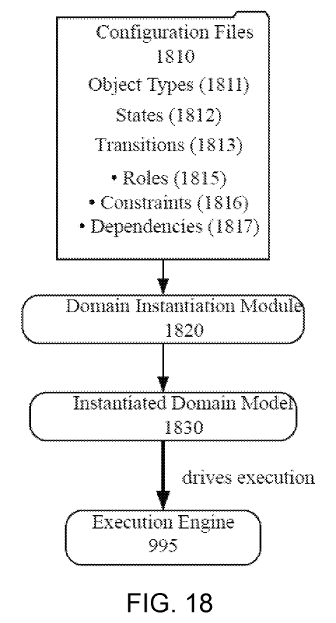

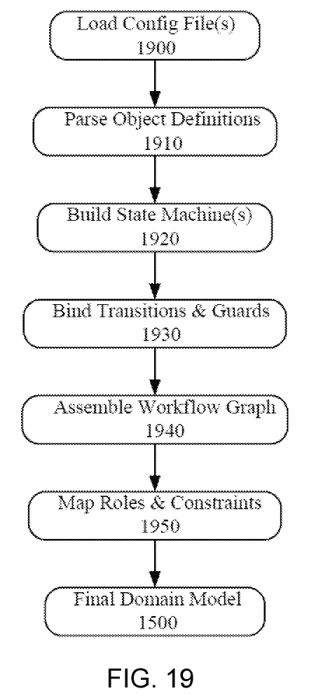

FIG. 18 illustrates a separation of an engine configuration from a corresponding execution engine. FIG. 19 illustrates a domain instantiation process. Accordingly, the figures combine to illustrate a domain-agnostic execution substrate that loads object types, states, transitions, workflows, roles, and constraints from external configuration files and enforces deterministic, causally consistent execution across objects and entities.

In the context of the execution substrate or engine, many of the definitions discussed above continue to be accurate. Additional, a domain configuration is a set of external configuration files defining the structure and behavior of an operational domain. Such configurations may specify:
a. object types,
b. states,
c. transitions,
d. workflows,
e. roles,
f. constraints,
g. dependency graphs, and
h. approval requirements.

Domain configurations may be loaded dynamically without modifying execution engine code.

A domain model is then a governed representation of the configured domain that the execution engine constructs after loading configuration files. The domain model specifies permissible transitions, constraints, dependency structures, and role mappings.

An execution engine, discussed above and below, is then a domain-agnostic core component that enforces governed state transitions according to rules defined in the domain model and causal world model. It typically does not contain domain-specific semantics.

A propagation mechanism is a mechanism for synchronizing state changes across dependent objects or across entities maintaining mirrored or interrelated representations of governed objects.

A mirrored state or a multi-ledger state is a representation where multiple entities maintain synchronized views of the same object or transition. Transitions may require acceptance from more than one entity before finalization.

An entity is any organizational or logical boundary participating in governed state transitions, including departments, systems, services, or separate organizations.

Runtime composability is the capability of the execution engine to support new or modified domains by loading updated configuration files at runtime without altering engine code.

As noted above, following validation and authorization of a state transition (at 980), the method may hand off the request to an execution engine 995 or substrate. As shown in FIG. 15, such a handoff may trigger the corresponding real-world effect by updating states (1510), triggering dependent transitions (1520) and confirming output (1530). Accordingly, the execution substrate 995 may apply the transition according to governed rules and update the world model 1400.

Such implementation may include constructing an instantiated domain model 1500 for driving execution by a domain agnostic execution engine (980). The execution engine (980) may then enforce governed state transitions. The construction of the instantiated domain model may then include loading a configuration file (1900), as discussed below, generating object schemas by parsing object definitions (1910), creating state machine structures (1920), binding transitions to conditional rules (1930), loading and assembling workflow graphs (1940), building dependency maps and mapping roles and constraints to transition permissions (1950).

The construction of the instantiated domain model may then be governed by one of a plurality of configuration files defining the corresponding domain model. Different configuration files of the plurality may define different domain models, each describing the corresponding domain semantics. The execution engine itself 995 may be domain agnostic and may then be driven by any of the different domain models. By separating execution logic from domain semantics, the substrate enables dynamic instantiation of entirely new operational domains without modifying core engine code.

During execution, once the instantiated domain model is constructed, the corresponding transition may be executed. Accordingly, the model may receive the requested transition which may define primary object state transitions (1600) as well as propagation rules (1610) at a propagation engine (1620).

The propagation engine (1620) may then start the transition (1630) by implementing the primary object state transition (defined at 1600) according to the propagation rules (1610). Updates are then applied to a ledger (1640) associated with the first entity 1400a and a ledger (1650) associated with the second entity 1400b.

Each ledger (1640, 1650) then provides a confirmation signal, resulting in confirmation by the execution engine 995 that all entities have authorized the transition (1660). If confirmations are received from the required entities, the flow proceeds to commit transaction (1670), finalizing the multi-entity transition. If confirmation is not achieved, the flow proceeds to rollback transaction (1680), illustrating prevention of partial or inconsistent updates across the entities 1400a, b.

Similarly, FIG. 17 is a block diagram illustrating a composite domain operation in which multiple independently configured domains execute on a shared engine within a unified causal world model 1770. Multiple configurations, configuration A (1700), configuration B (1710), and configuration C (1720), are depicted as separate external artifacts that instantiate corresponding domain models: domain model A (1730), domain model B (1740), and domain model C (1750).

The domain models provide execution instructions to a shared execution engine (1760), indicating that the engine supports concurrent execution across multiple domains. The domain models also contribute states to the unified causal world model (1770), illustrating a consolidated representation of governed state and dependencies across domains. The unified causal world model (1770) provides governed consistency back to the execution engine (995), indicating that execution is constrained and validated by an integrated causal representation even while multiple independent domain configurations are active.

Accordingly, as shown in FIG. 18, separation is provided between a domain-agnostic execution engine 995 and domain-defining configuration files 1810. One or more configuration files 1810 are depicted as external artifacts containing domain semantics, including object types 1811, states 1812, transitions 1813, workflows 1814, roles 1815, constraints 1816, and dependencies 1817.

Object types (1811) may then include attribute schemas, identifiers, and relationships.

States (1812) include all allowable lifecycle conditions for each object type.

Transitions (1813) include allowed movements between states, including required conditions.

Workflows (1814) include structured sequences or graphs of transitions that express lifecycle logic.

Roles (1815) and personas include actors permitted to perform specific transitions.

Dependencies (1817) include conditions expressing relationships between object transitions (e.g., transition A requires transition B).

Constraints (1816) include logical rules and conditions governing transitions, such as field requirements, cardinality rules, or temporal conditions.

These configurations are loaded by the execution engine at runtime. Each configuration file may define a standalone domain, or multiple configuration files may collectively define a composite operational environment.

The configuration files 1810 are provided to a domain instantiation module 1820 that constructs an instantiated domain model 1830. The instantiated domain model 1830 is shown driving execution by the execution engine 995, which is explicitly labeled domain-agnostic, illustrating that domain-specific behavior is defined by configuration and instantiated models rather than embedded in engine code.

Upon loading configuration files, the execution engine therefore constructs a domain model (1830). This instantiation involves:
a. generating object schemas,
b. creating state machine structures,
c. binding transitions to conditional rules,
d. loading workflow graphs,
e. building dependency maps,
f. mapping roles to transition permissions.

The instantiated domain model is authoritative and governs all runtime behavior. The instantiation process is repeatable and composable: loading a new or revised configuration file instantly redefines the operational domain without requiring engine modification.

The execution engine then applies state transitions in a deterministic and governed manner.

Transition Validation - as discussed above with respect to FIG. 12, for any proposed transition, the engine verifies:
a. the object is in a valid source state (1210),
b. the transition is allowed according to the domain model (1200),
c. all required dependencies are satisfied (1220),
d. all constraints are met (1230),
e. any required approvals have been collected, and
f. referenced objects are valid and compatible.

Transition Application - if validated, the transition is implemented:
a. the engine updates the object’s state,
b. modifies governed attributes,
c. enforces relationship rules.

Dependent Transitions - based on dependency definitions:
a. one transition may trigger additional transitions in related objects,
b. the engine ensures dependent transitions are computed and applied atomically or sequentially as required. Rejection – if validation fails, no state is mutated.

The engine returns reasons for failure to the caller (e.g., the execution gateway).

In many operational environments, multiple entities maintain synchronized or mirrored views of governed objects. Propagation of changes may then be across multiple entities. The substrate enforces consistency by:
a. applying mirrored transitions across entities,
b. coordinating bilateral or multilateral acceptance rules,
c. preventing partial or inconsistent updates,
d. reconciling cross-entity dependencies during transition execution.

The propagation mechanism may maintain multi-ledger representations that co-evolve deterministically.

The execution substrate supports dynamic integration of new domains by loading:
a. additional configuration files,
b. modified object schemas,
c. updated transition definitions,
d. new workflow graphs.

No changes to the execution engine are required. This architecture allows rapid adaptation to evolving requirements and ensures the substrate remains applicable across diverse industries and operational domains.

While the execution substrate may receive transition instructions from multiple sources, the invention assumes that autonomous agents and human users will typically interact through an execution gateway that:
a. interprets semantic intent,
b. applies intent-scoped authorization,
c. validates proposals before reaching the engine.

Such an execution gateway is described in detail above. Once a proposal is approved by the gateway, the substrate completes the low-level transition execution according to governed model rules.

The following embodiments illustrate representative ways in which the configurable execution substrate may operate. These examples are domain-agnostic and expressed solely through objects, states, transitions, workflows, and governed execution behavior. These embodiments are exemplary only and are not limiting.

One example is a multi-stage config-defined lifecycle:

A configuration file defines a generic object type, such as Record, with lifecycle states including Created, Submitted, UnderReview, Approved, Rejected, and Archived. The configuration defines:
a. permissible transitions between states,
b. conditions required for specific transitions,
c. any required approvals,
d. roles allowed to perform transitions.

The execution engine loads this configuration and constructs:
a. the Record state machine,
b. workflow paths,
c. role-transition mappings,
d. dependency rules.

When a transition request is issued (for example, from Submitted to UnderReview), the execution engine:
a. verifies that the object is currently in Submitted,
b. checks that required prerequisites (e.g., metadata completeness) are satisfied,
c. ensures that the requesting actor has the appropriate role,
d. applies the transition and updates the governed causal world model.

Another example is a configurable compliance workflow:

A configuration defines an object type called Complianceltem with states such as Pending, UnderAssessment, Validated, and Revoked. It defines:
a. transitions (e.g., assess, validate, revoke),
b. evidence requirements,
c. dependency rules linking ComplianceItem transitions to the states of other objects.

The execution engine:
a. loads the ComplianceItem domain,
b. enforces that certain operational objects cannot enter specific states unless corresponding ComplianceItems are Validated,
c. computes dependent transitions when a ComplianceItem is validated or revoked.

This demonstrates cross-object constraint enforcement.

Another example is a configured scientific or technical process:

A configuration file defines a multi-step technical workflow involving a ProcessInstance object with states such as Draft, CandidateGenerated, Simulated, Evaluated, ApprovedForExecution, and Closed. The file defines:

required component objects (e.g., ParameterSet, SimulationResult),

dependency rules (e.g., simulation must occur before evaluation),

state-transition guards (e.g., Evaluated requires simulation output meeting thresholds).

The engine:

instantiates the domain,

enforces transition order,

triggers dependent transitions (e.g., generating additional simulations when evaluations fail thresholds),

prevents state advancement if constraints are violated.

Another example is a config-defined resource/inventory-like state machine:

A configuration defines a Resource object with properties such as quantity, reserved amount, and thresholds. States include Available, Reserved, Committed, Consumed, and Reconciled. Rules specify:
a. that reserved + committed ≤ available quantity,
b. that reconciliation transitions require justification metadata,
c. that related Resource objects in other entities maintain synchronized quantities.

Upon receiving a transition request:
a. the engine verifies numeric constraints,
b. checks related objects,
c. updates the Resource state,
d. triggers propagation to mirrored Resource objects in other entities.

This embodiment demonstrates multi-entity consistency enforcement.

Another example is multi-domain operation through configuration:

Multiple configuration files are loaded at runtime, each defining a different domain (e.g., a lifecycle domain, a compliance domain, a technical process domain, and a resource domain). The execution engine:
a. instantiates all domains simultaneously,
b. maintains an integrated governed causal world model,
c. enforces dependencies across domains,
d. executes transitions across objects belonging to different domains.

This demonstrates the substrate’s ability to unify semantics across heterogeneous operational areas without engine changes.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudo-code, and the like represent various processes which may be substantially represented in computer readable media and so executed by a computer or processor, whether or not such computer or processor is explicitly shown.

The embodiments of the invention disclosed herein may comprise a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device may receive computer readable program instructions from the network and forward the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++, Java, Perl, Python or the like, and conventional procedural programming languages, such as the "C" programming language or similar programming languages. The computer readable program instructions may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and/or computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

A processor or processor circuity may include a device that has any combination of hardware, circuity, and software. The hardware and circuitry examples may comprise a parallel processor, a processor array, a vector processor, a scalar processor, a multi-processor, a microprocessor, a communication processor, a network processor, a logic circuit, a queue management device, a central processing unit (CPU), a microprocessing unit (MPU), system on a chip (SoC), a digital signal processor (DSP), an integrated circuit (IC), an application specific integrated circuit (ASIC), a programmable logic device (PLD), and a field programmable gate array (FPGA). A processor or processor circuity may include one or more processors, one or more circuits and/or software, that responds to and processes basic computer instructions and carries out the instructions of a computer program by performing the basic arithmetic, logical, control and input/output (I/O) operations specified by the instructions, one or more of: an arithmetic logic unit (ALU), which may carry out arithmetic and logic operations on the operands in instructions; a floating point unit (FPU), also known as a math coprocessor or numeric coprocessor, which is a specialized coprocessor that may manipulate numbers more quickly than the basic microprocessor circuitry can in some cases; one or more registers, which may hold instructions and other data and supply operands to the ALU and store the results of operations; and cache memory, which may save time compared to having to get data from random access memory (RAM). A processor or processor circuity may also include one or more circuits comprising electronic components, such as resistors, memristors, power sources, magnetic devices, motors, generators, solenoids, microphones, speakers, transistors, capacitors, inductors, diodes, semiconductors, switches, antennas, transducers, sensors, detectors, vacuums, tubes, amplifiers, radio receivers, crystals, and oscillators connected by conductive wires or traces through which electric current can flow. The combination of components and wires may allow various simple and complex operations to be performed: signals may be amplified, computations can be performed, and data can be moved from one place to another.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A computer-implemented method for governing execution of tasks comprising:
receiving, at a computing system, a request to implement a state transition for triggering a real-word effect;
identifying, in the request, a declared task type associated with the proposed transition;
deriving a task-specific authority profile based at least partially on the declared task type, the task-specific authority profile comprising a plurality of discrete required permission levels to execute a task of the declared task type;
determining an actor-specific authority profile based on a source of the received request to implement the state transition, the actor-specific authority profile defining an actor-specific permission level associated with each of the discrete permissions of the task-specific authority profile;
creating an instance-specific authority profile, the instance-specific authority profile comprising an instance-specific permission level corresponding to a narrower of the corresponding task-specific required permission level and the actor-specific permission level;
determining that the state transition is permitted to exist as a binding operational state prior to implementation upon determining that the instance-specific authority profile defines sufficient permissions for each discrete required permission level.

2. The method of claim 1 further comprising evaluating the requested state transition against a governed causal world model representing current state data and dependency requirements and defining a hypothetical resulting state following the requested state transition, wherein the proposed state transition is determined to be admissible upon determining that the hypothetical resulting state is valid.

3. The method of claim 2 wherein the hypothetical resulting state is validated deterministically to confirm required predecessor states, mandatory linked object existence, and dependency conditions across multiple objects.

4. The method of claim 2 further comprising determining that the hypothetical resulting state is invalid, identifying a modification to the request that preserves a semantic intent of the request, applying the identified modification to the request and reevaluating the requested state transition.

5. The method of claim 2 wherein the governed causal world model comprises a current state of every governed object, relationships and dependencies among objects, and cross-entity state mappings.

6. The method of claim 5 wherein the evaluating of the requested state transition against the governed causal world model comprises confirming that all object states of the hypothetical resulting state conform to allowed object states, that all dependencies of the hypothetical resulting state conform to dependency rules of the causal world model, and that all predicted consequences resulting from the hypothetical resulting state conform to cross-entity propagation rules.

7. The method of claim 5 wherein the evaluating of the requested state transition against the governed causal world model comprises applying deterministic validation rules to a causal execution graph, wherein the results of the application to the causal execution graph determine whether the hypothetical resulting state is valid.

8. The method of claim 7 wherein the causal execution graph defines allowed object states, allowed object transitions, and dependency rules across a plurality of entities.

9. The method of claim 8 wherein the actor-specific authority profile is associated with one of the plurality of entities, and wherein the one of the plurality of entities does not have direct access to information governing the causal world model with respect to a second entity of the plurality of entities.

10. The method of claim 9 wherein implementation of the state transition triggers a creation of a legally binding agreement between the first entity and the second entity.

11. The method of claim 9 wherein the state transition is to initiate a release of physical goods for shipment and wherein implementation of the state transition triggers generation of a warehouse pick instruction or carrier dispatch at the second entity.

12. The method of claim 1 wherein upon receiving the request to implement a state transition, an ingestion interface normalizes the request prior to identifying the declared task type.

13. The method of claim 12 wherein following normalization, the identification of the declared task type is based on semantically mapping the normalized request to one or more predefined task type.

14. The method of claim 13 wherein the discrete required permission levels are defined based on the one or more predefined task type.

15. The method of claim 14 wherein the actor-specific authority profile defines at least one actor-specific permission level broader than a corresponding required permission level of the discrete required permission level, and wherein the resulting instance-specific authority profile comprises an instance-specific permission level narrower than the at least one actor-specific permission level.

16. The method of claim 14 wherein the request to implement a state transition comprises an identity of a source of the request, a semantic action, an object reference, and at least one proposed attribute value.

17. The method of claim 16 wherein the semantic action requires a modification of one field of a plurality of fields but does not require modification of a second field of the plurality of fields, and wherein the actor-specific authority profile defines a permission level sufficient to modify both the first and second field of the plurality of fields, and wherein the instance-specific permission level authorizes modification of the first field but not the second field of the plurality of fields.

18. The method of claim 14 wherein the discrete required permission levels include at least one variable permission level, wherein the resulting instance-specific authority profile contains a corresponding instance-specific permission level based on the corresponding actor-specific permission level upon determining that the actor-specific permission level is within a range of the variable permission level.

19. The method of claim 14 wherein the identity of the source of the request identifies two actors having different actor-specific authority profiles, and wherein a resulting actor-specific authority profile includes a highest permission level associated with one of the corresponding actors for each of the actor-specific permission levels.

20. The method of claim 19 wherein the two actors are associated with two corresponding distinct entities, and wherein a relationship between the two distinct entities is defined by a governed causal world model representing current state data and dependency requirements, and wherein the task-specific authority profile defines discrete required permission levels at each of the two distinct entities.

21. The method of claim 1 wherein the state transition is to initiate a release of physical goods for shipment and wherein implementation of the state transition triggers generation of a warehouse pick instruction or carrier dispatch.

22. The method of claim 1 wherein the state transition is to initiate issuance of a refund, credit, or payment, wherein implementation of the state transition triggers transfer of funds or settlement of a payment instrument.

23. The method of claim 1 wherein the state transition is to initiate a write or delete operation against persistent storage, wherein implementation of the state transition triggers irreversible modification or destruction of stored data.

24. The method of claim 1 further comprising implementing the state transition to trigger the real-world effect following determination that the proposed state transition is admissible.

25. The method of claim 24 wherein implementing the state transition comprises constructing an instantiated domain model for driving execution by a domain agnostic execution engine.

26. The method of claim 25 wherein constructing the instantiated domain model comprises generating object schemas, creating state machine structures, binding transitions to conditional rules, loading workflow graphs, building dependency maps, and mapping roles to transition permissions.

27. The method of claim 26 wherein the constructing of the instantiated domain model is governed by one of a plurality of configuration files and wherein different configurations files of the plurality of configuration files define different domain models, and wherein the domain agnostic execution engine can be driven by any of the different domain models.
